(19) United States
(12) Patent Application Publication
(10) Pub. No.: US 2025/0310797 A1
(43) Pub. Date: Oct. 2, 2025

(54) ARTIFICIAL INTELLIGENCE-BASED LIFE CYCLE MANAGEMENT SIGNALING

(71) Applicant: QUALCOMM Incorporated, San Diego, CA (US)

(72) Inventors: Rajeev KUMAR, San Diego, CA (US); Aziz GHOLMIEH, Del Mar, CA (US); Punyaslok PURKAYASTHA, San Diego, CA (US); Hamed PEZESHKI, San Diego, CA (US)

(21) Appl. No.: 19/092,935

(22) Filed: Mar. 27, 2025

Related U.S. Application Data
(60) Provisional application No. 63/572,797, filed on Apr. 1, 2024.

(51) Int. Cl. H04W 24/02; H04B 7/06; H04W 24/10

(52) U.S. Cl. CPC H04W 24/02; H04B 7/06964; H04W 24/10

(57) ABSTRACT

Methods, systems, and devices for wireless communications are described. Disclosed techniques relate to monitoring performance parameters in mobility cases for life cycle management (LCM) for artificial intelligence (AI) or machine language functionalities of a user equipment (UE). In UE-based LCM for AI functionalities, a UE may monitor and track performance indicators for AI functionalities of the UE across network entities (e.g., across serving cells). In network-based LCM for AI functionalities, the serving network entity may obtain information regarding UE performance indicators from another network entity. For example, when a UE reports an AI functionality, the network entity may obtain the information regarding UE performance for that AI functionality from the other network entity and may make an LCM decision based on the obtained information.

### CROSS REFERENCES

The present Application for Patent claims benefit of U.S. Provisional Patent Application No. 63/572,797 by KUMAR et al., entitled “ARTIFICIAL INTELLIGENCE-BASED LIFE CYCLE MANAGEMENT SIGNALING,” filed Apr. 1, 2024, assigned to the assignee hereof, and expressly incorporated herein.

### INTRODUCTION

The following relates to wireless communications, and more specifically to management of artificial intelligence (AI) or machine learning (ML)-based functionalities.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support AI-based life cycle management (LCM) signaling.

A method for wireless communications by a user equipment (UE) is described. The method may include receiving, from a first network entity, a control message including an indication of one or more monitoring parameters associated with LCM of one or more AI-based functionalities or models of the UE and performing, based on satisfaction of at least one monitoring parameter of the one or more monitoring parameters for a communication link associated with a second network entity, an LCM action associated with at least one AI-based functionality or model of the one or more AI-based functionalities or models.

An apparatus for wireless communications at a UE is described. The apparatus may include one or more memories and one or more processors coupled with the one or more memories. The one or more processors may be configured to cause the UE to receive, from a first network entity, a control message including an indication of one or more monitoring parameters associated with LCM of one or more AI-based functionalities or models of the UE and perform, based on satisfaction of at least one monitoring parameter of the one or more monitoring parameters for a communication link associated with a second network entity, an LCM action associated with at least one AI-based functionality or model of the one or more AI-based functionalities or models.

Another UE for wireless communications is described. The UE may include means for receiving, from a first network entity, a control message including an indication of one or more monitoring parameters associated with LCM of one or more AI-based functionalities or models of the UE and means for performing, based on satisfaction of at least one monitoring parameter of the one or more monitoring parameters for a communication link associated with a second network entity, an LCM action associated with at least one AI-based functionality or model of the one or more AI-based functionalities or models.

A non-transitory computer-readable medium storing code for wireless communications at a UE is described. The code may include instructions executable by one or more processors to cause the UE to receive, from a first network entity, a control message including an indication of one or more monitoring parameters associated with LCM of one or more AI-based functionalities or models of the UE and perform, based on satisfaction of at least one monitoring parameter of the one or more monitoring parameters for a communication link associated with a second network entity, an LCM action associated with at least one AI-based functionality or model of the one or more AI-based functionalities or models.

Some examples of the method, apparatuses, UEs, and non-transitory computer-readable medium described herein may further include operations, features, means, or instructions for transmitting, to one of the first network entity or the second network entity, an LCM request message, where the LCM action may be performed based on the LCM request message.

Some examples of the method, apparatuses, UEs, and non-transitory computer-readable medium described herein may further include operations, features, means, or instructions for receiving, from the first network entity or the second network entity and based on the LCM request message, an LCM control message that indicates a configuration for the at least one AI-based functionality, where the LCM action may be based on the configuration.

In some examples of the method, apparatuses, UEs, and non-transitory computer-readable medium described herein, the LCM request message includes a request for the configuration.

In some examples of the method, apparatuses, UEs, and non-transitory computer-readable medium described herein, the LCM request message includes an indication of the satisfaction of the at least one monitoring parameter.

Some examples of the method, apparatuses, UEs, and non-transitory computer-readable medium described herein may further include operations, features, means, or instructions for transmitting, to one of the first network entity or the second network entity, a second control message that indicates performance of the LCM action.

In some examples of the method, apparatuses, UEs, and non-transitory computer-readable medium described herein, the performing the LCM action may include operations, features, means, or instructions for activating the at least one AI-based functionality or model, deactivating the at least one AI-based functionality or model, switching the at least one AI-based functionality or model from a first configuration to another AI-based functionality or model, or switching the at least one AI-based functionality or model to a non-AI-based UE function.

In some examples of the method, apparatuses, UEs, and non-transitory computer-readable medium described herein, the one or more AI-based functionalities or models include layer 1 beam predictions, layer 3 beam measurements, radio link failure predictions, handover predictions, beam failure predictions, measurement event prediction, or a combination thereof.

In some examples of the method, apparatuses, UEs, and non-transitory computer-readable medium described herein, the one or more monitoring parameters include an accuracy of the layer 1 beam predictions, an accuracy of the layer 3 beam measurements, an accuracy of the radio link failure predictions, an accuracy of the handover predictions, an accuracy of the beam failure predictions, satisfaction of a counter, or a combination thereof.

A method for wireless communications by a first network entity is described. The method may include obtaining a capability message that indicates one or more AI-based functionalities or models of a UE, obtaining, from a second network entity, a control message that indicates one or more performance parameters associated with the UE, the one or more performance parameters associated with at least one AI-based functionality or model of the one or more AI-based functionalities or models, and outputting, based on the capability message and the control message, an LCM control message that indicates a configuration for the at least one AI-based functionality or model.

An apparatus for wireless communications at a first network entity is described. The apparatus may include one or more memories and one or more processors coupled with the one or more memories. The one or more processors may be configured to cause the first network entity to obtain a capability message that indicates one or more AI-based functionalities or models of a UE, obtain, from a second network entity, a control message that indicates one or more performance parameters associated with the UE, the one or more performance parameters associated with at least one AI-based functionality or model of the one or more AI-based functionalities or models, and output, based on the capability message and the control message, an LCM control message that indicates a configuration for the at least one AI-based functionality or model.

Another first network entity for wireless communications is described. The first network entity may include means for obtaining a capability message that indicates one or more AI-based functionalities or models of a UE, means for obtaining, from a second network entity, a control message that indicates one or more performance parameters associated with the UE, the one or more performance parameters associated with at least one AI-based functionality or model of the one or more AI-based functionalities or models, and means for outputting, based on the capability message and the control message, an LCM control message that indicates a configuration for the at least one AI-based functionality or model.

A non-transitory computer-readable medium storing code for wireless communications at a first network entity is described. The code may include instructions executable by one or more processors to cause the first network entity to obtain a capability message that indicates one or more AI-based functionalities or models of a UE, obtain, from a second network entity, a control message that indicates one or more performance parameters associated with the UE, the one or more performance parameters associated with at least one AI-based functionality or model of the one or more AI-based functionalities or models, and output, based on the capability message and the control message, an LCM control message that indicates a configuration for the at least one AI-based functionality or model.

In some examples of the method, apparatuses, first network entities, and non-transitory computer-readable medium described herein, obtaining the control message from the second network entity may include operations, features, means, or instructions for obtaining, from a registration entity, a message including an indication of a logical or physical model associated with a UE type of the UE, the logical or physical model associated with the one or more performance parameters, where the registration entity includes the second network entity.

Some examples of the method, apparatuses, first network entities, and non-transitory computer-readable medium described herein may further include operations, features, means, or instructions for obtaining, from the registration entity, advertisement information that indicates a set of UE types or a set of respective logical models, where the set of UE types including the UE type, or the set of respective logical models including the logical or physical model.

Some examples of the method, apparatuses, first network entities, and non-transitory computer-readable medium described herein may further include operations, features, means, or instructions for obtaining, from a third network entity, one or more additional performance indicators associated with the one or more performance parameters, where transmission of the LCM control message may be based on an application of the one or more additional performance indicators to the logical or physical model.

In some examples of the method, apparatuses, first network entities, and non-transitory computer-readable medium described herein, the obtaining the control message from the second network entity may include operations, features, means, or instructions for obtaining, from an access and mobility entity, the control message that indicates the configuration for the at least one AI-based functionality or model, where the one or more performance parameters may be associated with the configuration.

In some examples of the method, apparatuses, first network entities, and non-transitory computer-readable medium described herein, the control message that indicates the configuration may be based on one or more additional performance indicators for the UE associated with the at least one AI-based functionality or model stored at an operations and management entity.

In some examples of the method, apparatuses, first network entities, and non-transitory computer-readable medium described herein, the obtaining the control message from the second network entity may include operations, features, means, or instructions for obtaining, from an operations and management entity, the control message that indicates the configuration for the at least one AI-based functionality or model, where the configuration includes the one or more performance parameters.

In some examples of the method, apparatuses, first network entities, and non-transitory computer-readable medium described herein, the control message that indicates the configuration may be based on one or more additional performance indicators for the UE associated with the at least one AI-based functionality or model stored at the operations and management entity.

Some examples of the method, apparatuses, first network entities, and non-transitory computer-readable medium described herein may further include operations, features, means, or instructions for obtaining assistance information that indicates an identifier for the UE and outputting, to the second network entity, a request message for one or more additional performance indicators for the UE, where the request message includes the identifier for the UE, and where obtaining the control message includes obtaining the one or more additional performance indicators for the UE associated with the one or more performance parameters based on inclusion of the identifier in the request message.

In some examples of the method, apparatuses, first network entities, and non-transitory computer-readable medium described herein, the identifier includes an encrypted identifier.

Some examples of the method, apparatuses, first network entities, and non-transitory computer-readable medium described herein may further include operations, features, means, or instructions for outputting, to the second network entity, a report indicating one or more second performance indicators associated with the configuration for the at least one AI-based functionality or model based on communication between the UE and the first network entity.

In some examples of the method, apparatuses, first network entities, and non-transitory computer-readable medium described herein, the configuration includes activating the at least one AI-based functionality or model, deactivating the at least one AI-based functionality or model, switching the at least one AI-based functionality or model from a second configuration to another AI-based functionality or model, or switching the at least one AI-based functionality or model to a non-AI-based UE function.

In some examples of the method, apparatuses, first network entities, and non-transitory computer-readable medium described herein, the one or more AI-based functionalities or models include layer 1 beam predictions, layer 3 beam measurements, radio link failure predictions, handover predictions, beam failure predictions, or a combination thereof.

In some examples of the method, apparatuses, first network entities, and non-transitory computer-readable medium described herein, the one or more performance parameters includes an accuracy of the layer 1 beam predictions, an accuracy of the layer 3 beam measurements, an accuracy of the radio link failure predictions, an accuracy of the handover predictions, an accuracy of the beam failure predictions, satisfaction of a counter, or a combination thereof.

A method for wireless communications by a first network entity is described. The method may include obtaining, from a second network entity, a first control message that indicates one or more performance parameters associated with a UE, the one or more performance parameters associated with at least one AI-based functionality or model of one or more AI-based functionalities or models of the UE and outputting, to a third network entity in communication with the UE, a second control message based on the one or more performance parameters.

An apparatus for wireless communications at a first network entity is described. The apparatus may include one or more memories and one or more processors coupled with the one or more memories. The one or more processors may be configured to cause the first network entity to obtain, from a second network entity, a first control message that indicates one or more performance parameters associated with a UE, the one or more performance parameters associated with at least one AI-based functionality or model of one or more AI-based functionalities or models of the UE and output, to a third network entity in communication with the UE, a second control message based on the one or more performance parameters.

Another first network entity for wireless communications is described. The first network entity may include means for obtaining, from a second network entity, a first control message that indicates one or more performance parameters associated with a UE, the one or more performance parameters associated with at least one AI-based functionality or model of one or more AI-based functionalities or models of the UE and means for outputting, to a third network entity in communication with the UE, a second control message based on the one or more performance parameters.

A non-transitory computer-readable medium storing code for wireless communications at a first network entity is described. The code may include instructions executable by one or more processors to cause the first network entity to obtain, from a second network entity, a first control message that indicates one or more performance parameters associated with a UE, the one or more performance parameters associated with at least one AI-based functionality or model of one or more AI-based functionalities or models of the UE and output, to a third network entity in communication with the UE, a second control message based on the one or more performance parameters.

In some examples of the method, apparatuses, first network entities, and non-transitory computer-readable medium described herein, outputting the second control message may include operations, features, means, or instructions for outputting an LCM control message that indicates a configuration for the at least one AI-based functionality or model.

In some examples of the method, apparatuses, first network entities, and non-transitory computer-readable medium described herein, the configuration may be based on one or more additional performance indicators for the UE associated with the at least one AI-based functionality or model stored at an operations and management entity.

In some examples of the method, apparatuses, first network entities, and non-transitory computer-readable medium described herein, the obtaining the first control message from the second network entity may include operations, features, means, or instructions for obtaining, from an operations and management entity, the first control message that indicates the configuration for the at least one AI-based functionality or model, where the configuration includes the one or more performance parameters.

In some examples of the method, apparatuses, first network entities, and non-transitory computer-readable medium described herein, the configuration includes activating the at least one AI-based functionality or model, deactivating the at least one AI-based functionality or model, switching the at least one AI-based functionality or model from a second configuration to another AI-based functionality or model, or switching the at least one AI-based functionality or model to non-AI-based UE function.

In some examples of the method, apparatuses, first network entities, and non-transitory computer-readable medium described herein, the one or more AI-based functionalities or models include layer 1 beam predictions, layer 3 beam measurements, radio link failure predictions, handover predictions, beam failure predictions, measurement event prediction or a combination thereof.

Some examples of the method, apparatuses, first network entities, and non-transitory computer-readable medium described herein may further include operations, features, means, or instructions for communicating, with the second network entity and prior to obtaining the first control message, a third control message that indicates a subscription for a model identifier associated with the UE, the model identifier associated with the one or more performance parameters, receiving, from the third network entity, a first report message indicating one or more additional performance indicators for the UE associated with the at least one AI-based functionality or model, and outputting, to the second network entity, a second report message indicating the one or more additional performance indicators, where obtaining the first control message may be based on the second report message.

Some examples of the method, apparatuses, first network entities, and non-transitory computer-readable medium described herein may further include operations, features, means, or instructions for obtaining, from the third network entity, a first request message for the one or more performance parameters and outputting, to the second network entity and based on the first request message, a second request message for the one or more performance parameters, where obtaining the first control message may be based on the second request message.

In some examples of the method, apparatuses, first network entities, and non-transitory computer-readable medium described herein, the one or more performance parameters includes an accuracy of layer 1 beam predictions, an accuracy of layer 3 beam measurements, an accuracy of radio link failure predictions, an accuracy of handover predictions, an accuracy of beam failure predictions, satisfaction of a counter, accuracy of measurement event prediction, or a combination thereof.

### BRIEF DESCRIPTION OF THE DRAWINGS

FIG. 1 shows an example of a wireless communications system that supports AI-based LCM signaling in accordance with one or more aspects of the present disclosure.

FIG. 2 shows an example of a network architecture that supports AI-based LCM signaling in accordance with one or more aspects of the present disclosure.

FIG. 3 shows an example of an ML process that supports AI-based LCM signaling in accordance with one or more aspects of the present disclosure.

FIG. 4 shows an example of a wireless communications system that supports AI-based LCM signaling in accordance with one or more aspects of the present disclosure.

FIG. 5 shows an example of a process flow that supports AI-based LCM signaling in accordance with one or more aspects of the present disclosure.

FIG. 6 shows an example of a process flow that supports AI-based LCM signaling in accordance with one or more aspects of the present disclosure.

FIG. 7 shows an example of a process flow that supports AI-based LCM signaling in accordance with one or more aspects of the present disclosure.

FIG. 8 shows an example of a process flow that supports AI-based LCM signaling in accordance with one or more aspects of the present disclosure.

FIG. 9 shows an example of a process flow that supports AI-based LCM signaling in accordance with one or more aspects of the present disclosure.

FIG. 10 shows an example of a process flow that supports AI-based LCM signaling in accordance with one or more aspects of the present disclosure.

FIG. 11 shows an example of a process flow that supports AI-based LCM signaling in accordance with one or more aspects of the present disclosure.

FIGS. 12 and 13 show block diagrams of devices that support AI-based LCM signaling in accordance with one or more aspects of the present disclosure.

FIG. 14 shows a block diagram of a communications manager that supports AI-based LCM signaling in accordance with one or more aspects of the present disclosure.

FIG. 15 shows a diagram of a system including a device that supports AI-based LCM signaling in accordance with one or more aspects of the present disclosure.

FIGS. 16 and 17 show block diagrams of devices that support AI-based LCM signaling in accordance with one or more aspects of the present disclosure.

FIG. 18 shows a block diagram of a communications manager that supports AI-based LCM signaling in accordance with one or more aspects of the present disclosure.

FIG. 19 shows a diagram of a system including a device that supports AI-based LCM signaling in accordance with one or more aspects of the present disclosure.

FIGS. 20 through 22 show flowcharts illustrating methods that support AI-based LCM signaling in accordance with one or more aspects of the present disclosure.

### DETAILED DESCRIPTION

In some wireless communications systems, a user equipment (UE) may support AI and/or ML-based models and/or functionalities, such as for layer 1 beam predictions, layer 3 beam measurements, radio link failure predictions, handover predictions, or beam failure predictions. For example, for beam prediction, such a UE may collect data measurements (e.g., reference signal received power (RSRP) measurements, signal-to-interference-plus-noise-ratio (SINR) measurements, channel impulse response (CIR) measurements, or the like) for one or more directional beams based on measurements of reference signals (e.g., synchronization system blocks (SSBs), channel state information (CSI) reference signals (CSI-RSs), or other reference signals). For example, a UE may measure signals (e.g., SSBs or CSI-RSs) received via directional beams. The UE may train a given AI/ML model/functionality using measurements of a first set of beams of a network entity to predict measurements for a set of second, future beams of the network entity. Further, a trained AI/ML model/functionality may use measurements of a third set of beams to predict measurements for a fourth set of beams, which may be a process referred to as beam inference. AI/ML-based models and/or functionalities may refer to processes or processing frameworks that utilize one or more AI/ML algorithms to perform a given task, such as predicting one or more outputs based on one or more inputs. For instance, an AI/ML-based model and/or functionality may be employed to predict at least one outcome using one or more algorithms applied to a given input pattern. An AI/ML-based model or functionality may therefore support the recognition of patterns and the generation of predictions using input data. In some cases, inference may refer to one or more processes of inputting data to a trained AI/ML model to make predictions. The beams of the network entity whose measurements are predicted or output from the AI/ML model (e.g., the first set of beams or the third set of beams, which may correspond to the same set of beams) may be referred to as a set A beams and the beams of the network entity whose measurements are input to the AI/ML model (e.g., the second set of beams or the fourth set of beams, which may correspond to the same set of beams) may be referred to as set B beams. In some examples, predicting measurements may include computing values for measurements of the set of beams without relying on actual measurements performed for the set of beams by the UE.

In some examples, a UE may communicate AI/ML capabilities of the UE (e.g., an indication of the AI/ML functionalities supported by the UE) to the serving network entity for the UE. The UE may report performance indicators for the UE AI/ML functionalities. For example, performance indicators may include the percent of predictions which are correct based on subsequent measurements, the closeness of a prediction(s) to an actual measured value(s) (e.g., minimum mean square error), and/or the actual outcome of a prediction. For example, the performance indicators may include an accuracy of the layer 1 beam predictions, an accuracy of the layer 3 beam measurements, an accuracy of the radio link failure predictions, an accuracy of the handover predictions, an accuracy of the beam failure predictions, or satisfaction of a counter (e.g., handover failure counter, beam failure counter, radio link failure counter). The serving network entity may configure the AI/ML functionalities based on the performance indicators. In mobility cases, however, a new serving network entity for the UE may not have access to historical data of performance indicators for an AI/ML functionality/model of a UE. Accordingly, the new serving network entity may not identify a poorly performing UE for given AI/ML functionalities and/or models based on the UE performance when the UE was connected to a different serving network entity. Thus, in some cases, poorly performing UEs may reduce overall system performance across serving network entities if historical data of performance indicators for AI/ML functionalities and/or models is not considered. For example, a UE may be configured to perform an AI or ML functionality for which the UE has a historically poor performance when connected to other network entities, which may cause the network entity or UE to perform actions prematurely (e.g., trigger a premature handover, beam failure recovery, or radio link failure procedure) or too late (e.g., delayed triggering of a handover, beam failure recovery, or radio link failure procedure). As another example, a network entity may inefficiently assign resources to a UE based on poor AI or ML predictions (e.g., based on an inaccurate beam prediction), thereby reducing overall system performance.

Aspects of the present disclosure relate to techniques for monitoring performance parameters in mobility cases for life cycle management (LCM) for AI/ML functionalities. LCM for an AI/ML model may refer to the activation, deactivation, and/or configuration of parameters (e.g., input parameters and output parameters) for the AI/ML model. Such LCM may be implemented by the network or by the UE to track KPIs for a UE as the UE is connected to different serving network entities. In UE-based LCM for AI/ML functionalities, a UE may monitor and track performance indicators (e.g., key performance indicators (KPIs)) for AI/ML functionalities of the UE as the UE is connected to different serving network entities (e.g., across serving cells). For example, the KPIs for an AI/ML functionality may indicate the accuracy of predictions of the AI/ML functionality and may include the percent of predictions which are correct based on subsequent measurements, the closeness of a prediction(s) to an actual measured value(s) (e.g., minimum mean square error), and/or the actual outcome of a prediction. In some examples, the UE may autonomously make LCM decisions for AI/ML functionalities based on the performance indicators. The UE may perform an LCM action based on the LCM decision. For example, an LCM action may be activating an AI/ML functionality, deactivating the AI/ML functionality, switching the AI/ML functionality to a different configuration, switching to a fallback configuration for the AI/ML functionality, reconfiguring the AI/ML functionality, or using a non-AI/ML functionality. In some examples, the UE may transmit an LCM request message to the network based on the performance, and the network may transmit an LCM control message to the UE based on the LCM request. In some examples, the UE may transmit an indication of the performance indicators (e.g., historical performance indicators associated with AI/ML functionalities for the UE when the UE was connected to different serving network entities), and the network may make an LCM decision for the AI/ML functionalities of the UE based on the indicated performance indicators and transmit a corresponding LCM control message to the UE. For example, an LCM decision may include activating an AI/ML functionality, deactivating the AI/ML functionality, switching the AI/ML functionality to a different configuration, switching to a fallback configuration for the AI/ML functionality, reconfiguring the AI/ML functionality, or using a non-AI/ML functionality. In such examples, the UE may perform an LCM action based on the LCM control message.

In network-based LCM for AI/ML functionalities, the serving network entity may obtain information regarding UE performance indicators from another network entity, such as a prior serving network entity for the UE, a UE vendor registration platform, an operations and management (OAM) entity of the radio access network (RAN), or an access and mobility function (AMF). When a UE reports an AI/ML functionality, the network entity may obtain the information regarding UE performance for that AI/ML functionality from the other network entity and may make an LCM decision based on the obtained information. The serving network entity may transmit a corresponding LCM control message to the UE that indicates the LCM decision, and the UE may perform an LCM action based on the LCM control message. In some examples, UE vendors may store logical models indicative of UE AI/ML functionalities for different types of UEs in a UE vendor registration platform. Different serving network entities may store historical KPIs associated with UEs associated with the logical model identifier (ID) while those UEs are connected to the different serving network entities. A UE vendor registration platform (also referred to as a registration platform) may refer to a database accessible to a serving network entity at which UE vendors (e.g., manufacturers of UEs) may associate model IDs for different AI/ML functionalities with different UE types. The serving network entity may obtain the logical model that corresponds to the UE type and may obtain historical KPIs from other serving network entities based on the logical model ID. Accordingly, serving network entities may track KPIs for given UE types based on model IDs, as UEs of the same type may have similar performance for the same AI/ML functionality, and thus serving network entities and may not track individual UEs. As another example, the OAM entity of the RAN may maintain historical data of UE performance for AI/ML functionalities and may indicate, via an AMF, an LCM decision to the serving network entity for a given UE. As another example, a central entity such as a network data analytics function (NWDAF), an analytics data repository function (ADRF), or a unified data management (UDM) entity may maintain historical data of UE performance for AI/ML functionalities in accordance with a UE ID. When the UE reports an AI/ML functionality, the UE may report the UE ID to the serving network entity, and the serving network entity may request the historical data of the UE's performance for the AI/ML functionality based on the UE ID. For example, the UE ID may be an encrypted ID known to the UE and the central entity.

By implementing techniques for monitoring performance parameters in mobility cases for LCM for AI/ML functionalities, a wireless communications system may make LCM decisions based on historical performance of a UE across multiple cells. Accordingly, LCM decisions for AI/ML functionalities of a UE may be based on a longer-term view of a UE's performance. Accordingly, the network may identify poor performing UEs that may otherwise reduce overall system performance. Further, a serving cell or a UE may more quickly make LCM decisions for a UE when a UE first connects to the serving cell based on the monitored performance parameters for the UE.

Aspects of the disclosure are initially described in the context of wireless communications systems. Aspects of the disclosure are further illustrated by and described with reference to ML processes, process flows, apparatus diagrams, system diagrams, and flowcharts that relate to AI-based LCM signaling.

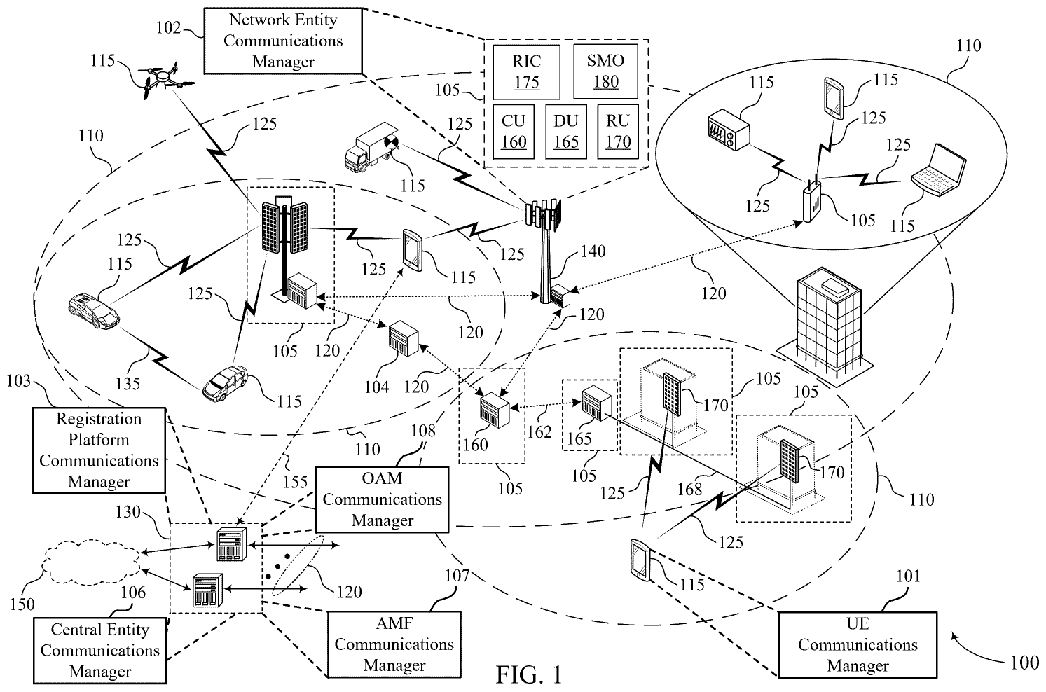

FIG. 1 shows an example of a wireless communications system 100 that supports AI-based LCM signaling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

In some examples, a UE 115 may support AI and/or ML models and/or functionalities, which the UE 115 may use to perform various wireless communications procedures (e.g., CSI prediction, beam selection, and/or beam prediction, among other examples). In such cases, the UE 115 may generate inference data using one or more AI/ML models/functionalities. Additionally, or alternatively, the UE 115 may perform LCM operations for a given AI/ML model and/or functionality (e.g., model or functionality selection, activation, deactivation, switching, and fallback, among other examples) based on one or more AI/ML models/functionalities. In some aspects, LCM may be model-based or functionality-based LCM procedures. As described herein, an AI functionality or AI model may be referred to as an ML functionality or ML model, or vice versa. That is, the terms “AI” and “ML” may, in some examples, be used interchangeably to refer to similar technologies, models, functions, algorithms, or any combination thereof. Similarly, the terms “model” and “functionality” may be used interchangeably. In some examples, ML operations may be considered a subset of AI operations. In any case, aspects of the features described herein may be referred to as AI functionalities, AI functions, AI models, AI services, AI operations, or the like, and such features may be similarly applicable to ML functionalities, ML functions, ML models, ML services, ML operations, or any combination thereof. Thus, reference to “ML” or “AI” may refer to ML, AI, or both, and the terms “AI” or “ML” should not be considered limiting to the scope of the claims or the disclosure.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

In some examples, a UE 115 may support AI and/or ML models and/or functionalities, which the UE 115 may use to perform various wireless communications procedures (e.g., channel state information (CSI) prediction, beam selection, and/or beam prediction, among other examples). In such cases, the UE 115 may generate inference data using one or more AI/ML models/functionalities. Additionally, or alternatively, the UE 115 may perform LCM operations for a given AI/ML model and/or functionality (e.g., model or functionality selection, activation, deactivation, switching, and fallback, among other examples) based on one or more AI/ML models/functionalities. In some aspects, LCM may be model-based or functionality-based LCM procedures. As described herein, an AI functionality or AI model may be referred to as an ML functionality or ML model, or vice versa. That is, the terms “AI” and “ML” may, in some examples, be used interchangeably to refer to similar technologies, models, functions, algorithms, or any combination thereof. Similarly, the terms “model” and “functionality” may be used interchangeably. In some examples, ML operations may be considered a subset of AI operations. In any case, aspects of the features described herein may be referred to as AI functionalities, AI functions, AI models, AI services, AI operations, or the like, and such features may be similarly applicable to ML functionalities, ML functions, ML models, ML services, ML operations, or any combination thereof. Thus, reference to “ML” or “AI” may refer to ML, AI, or both, and the terms “AI” or “ML” should not be considered limiting to the scope of the claims or the disclosure.

Techniques described herein, in addition to or as an alternative to be carried out between UEs 115 and network entities 105, may be implemented via additional or alternative wireless devices, including IAB nodes 104, DUs 165, CUs 160, RUs 170, and the like. For example, in some implementations, aspects described herein may be implemented in the context of a disaggregated RAN architecture (e.g., open RAN architecture). In a disaggregated architecture, the RAN may be split into three areas of functionality corresponding to the CU 160, the DU 165, and the RU 170. The split of functionality between the CU 160, DU 165, and RU 170 is flexible and as such gives rise to numerous permutations of different functionalities depending upon which functions (e.g., MAC functions, baseband functions, radio frequency functions, and any combinations thereof) are performed at the CU 160, DU 165, and RU 170. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more network entities 105 may include CUs 160, DUs 165, and RUs 170 and may be referred to as donor network entities 105 or IAB donors. One or more DUs 165 (e.g., and/or RUs 170) associated with a donor network entity 105 may be partially controlled by CUs 160 associated with the donor network entity 105. The one or more donor network entities 105 (e.g., IAB donors) may be in communication with one or more additional network entities 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of network entities 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host L3 (e.g., RRC, SDAP, PDCP, etc.) functionality and signaling. The at least one DU 165 and/or RU 170 may host lower layer, such as L1 and L2 (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a network entity 105 may additionally, or alternatively be performed by components of the disaggregated RAN architecture (e.g., IAB nodes, DUs, CUs, etc.).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The electromagnetic spectrum is often subdivided, based on frequency/wavelength, into various classes, bands, channels, etc. In 5G NR two initial operating bands have been identified as frequency range designations FR1 (410 MHZ-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, such as a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, a UE 115 and/or a network entity 105 may support AI/ML functionalities. For example, the UE 115 may support one or more AI/ML functionalities models for optimizing the wireless communications systems (e.g., efficient network energy saving, beam management, load balancing, and mobility optimization). The UE communications manager 101 may be configured to transmit, and a network communications manager 102 of the serving network entity 105 for the UE 115 may be configured to receive, an indication of UE AI/ML capabilities. The UE communications manager 101 may be configured to transmit, and the network communications manager 102 of the serving network entity 105 may be configured to receive, performance indicator(s) for the UE AI functionalities (e.g., accuracies of predictions), and the serving network entity 105 may configure the AI functionalities for the UE 115 based on the performance indicators. For example, the network communications manager 102 may be configured to transmit, and the UE communications manager 101 may be configured to receive, an LCM control message configuring the AI functionalities for the UE 115.

In some cases, the UE 11 may include a beam prediction AI/ML functionality. For example, a UE 115 may measure a first set of beams (“set B beams) and may use measurements over the first set of beams to predict characteristics of a second set of beams (“set A beams”). For example, a UE 115 may predict which beam of a first set of beams, referred to as set A beams, is a best beam for communicating messages with a network entity 105, where the beam being the best beam may refer to the beam being associated with a channel characteristic (e.g., L1-RSRP) that maximizes or minimizes a metric relative to the other beams of the first set of beams. In order to determine which beam of the first set of beams is the best beam, the UE 115 may measure one or more first channel characteristics of a second set of beams, referred to as set B beams, and may use the measurements from the second set of beams and an ML model to generate one or more predicted channel characteristics of the first set of beams. For instance, the UE 115 may measure L1-RSRPs of a first set of one or more reference signals received over the second set of beams and may use an ML model to predict L1-RSRPs of the set A beams.

In some examples, a UE 115 and/or a network entity 105 may perform spatial downlink beam prediction for set A beams using an AI or ML model based on measurement results of set B beams. For example, the set B beams may be wide beams (such as synchronization signal block (SSB) beams) while the set A beams may be narrow beams (such as CSI-RS beams). As another example, the set B beams may be narrow beams (such as CSI-RS beams) while the set A beams may be wide beams (such as SSB beams). In some examples, a UE 115 may perform temporal downlink beam prediction for set A beams using an ML model based on historic measurement results of set B beams. For example, the set A beams and the set B beams may be the same beams at different times (e.g., pure temporal beam predictions). As another example, the set A beams and the set B beams may be different beams at different times (e.g., temporal and spatial beam predictions).

Layer 1 beam measurements may be used to generate layer 3 beam measurements via filtering the layer 1 beam measurements. Layer 3 beam measurements may provide a longer-term view of a beam measurement than layer 1 measurements. Accordingly, layer 3 beam measurements may be used for RRM type decisions and procedures. In some examples, layer 1 beam measurements and layer 1 beam predictions may be used to generate layer 3 beam measurements.

In some examples, the UE 115 or the network entity 105 may monitor performance parameters in mobility cases for LCM for AI/ML functionalities. In UE-based LCM for AI functionalities, a UE 115 may monitor and track performance indicators for AI functionalities of the UE across network entities (e.g., across serving cells). In some examples, the UE 115 may autonomously make LCM decisions for AI/ML functionalities based on the performance indicators. In some examples, the UE communications manager 101 may transmit an LCM request message to the network based on the performance, and the network communications manager 102 may be configured to transmit an LCM control message to the UE 115 based on the LCM request. In some examples, the UE communications manager 101 may be configured to transmit an indication of the performance indicators (e.g., historical performance indicators of the UE 115 across different serving network entities 105), and the network may make an LCM decision for AI/ML functionalities of the UE 115 based on the indicated performance indicators. The network communications manager 102 may be configured to transmit a corresponding LCM control message to the UE 115.

In network-based LCM for AI functionalities, the serving network entity 105 may obtain information regarding UE performance indicators for an AI/ML functionality from another network entity 105, such as another serving network entity 105, an OAM of the core network 130, or an AMF of the core network 130. For example, when a UE 115 reports an AI/ML functionality, the network entity 105 may obtain the information regarding UE performance for that AI functionality from the other network entity 105 and may make an LCM decision based on the obtained information. The network communications manager 102 may be configured to transmit an LCM control message to the UE 115 based on the LCM decision.

In some examples, the core network 130 may include a registration platform, which may be a database accessible to a serving network entity 105 (e.g., via a backhaul communication link 120) at which UE vendors (e.g., manufacturers of UEs) may associate model IDs for different AI/ML functionalities with different UE types. The network communications manager 102 may obtain the logical model that corresponds to the UE type from the registration platform communications manager 103 (e.g., via the backhaul communication link 120) and may obtain historical KPIs from other serving network entities based on the logical model ID. Accordingly, using logical model IDs obtained from the registration platform, serving network entities 105 may track KPIs for given UE types, as UEs 115 of the same type may have similar performance for the same AI/ML functionality, and thus serving network entities 105 may not track individual UEs 115.

In some examples, the OAM of the RAN may maintain historical data of UE performance for AI/ML functionalities and may indicate, and the OAM may indicate (e.g., via the OAM communications manager 108 and/or via the AMF communications manager 107) an LCM decision to the serving network entity 105 for a given UE.

In some examples, a central entity of the core network 130 (e.g., a NWDAF, an ADRF, or a UDM) may maintain historical data of UE performance for AI/ML functionalities in accordance with a UE ID. When the UE 115 transmits, via the UE communications manager 101, an AI/ML functionality, the UE 115 may report the UE ID to the serving network entity 105. The serving network entity may transmit, via the network communications manager 102, a request to the central entity communications manager 106 (e.g., via the backhaul communication link 120) for historical data of the UE's performance for the AI/ML functionality based on the UE ID. The central entity communications manager 106 may transmit, to the network communications manager 102, the requested performance indicators.

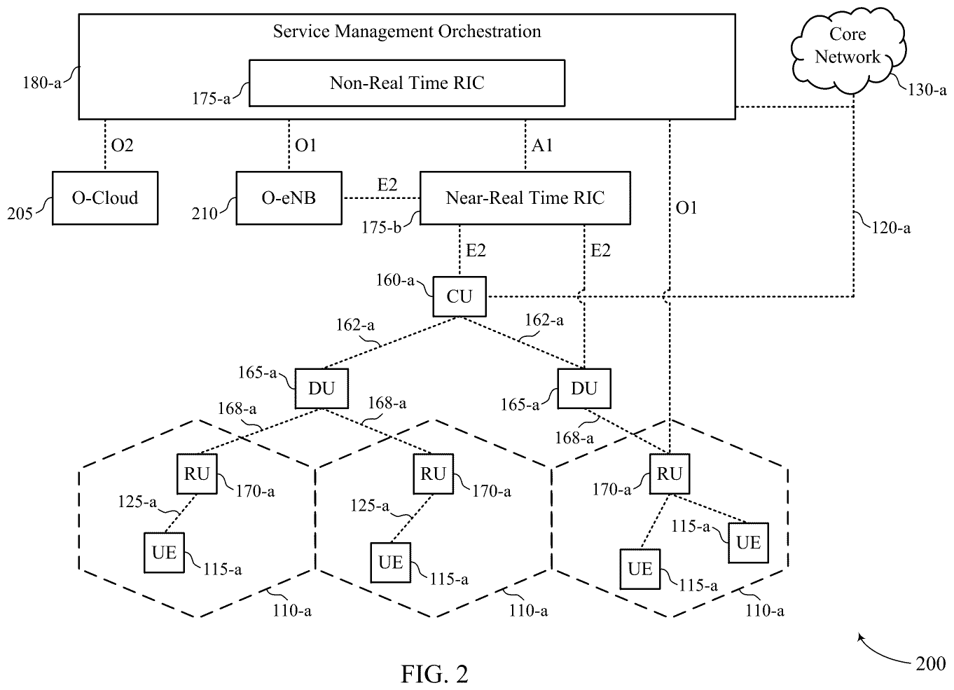

FIG. 2 shows an example of a network architecture 200 (e.g., a disaggregated base station architecture, a disaggregated RAN architecture) that supports AI-based LCM signaling in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (IFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity LCM (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, AI or ML workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., AI policies).

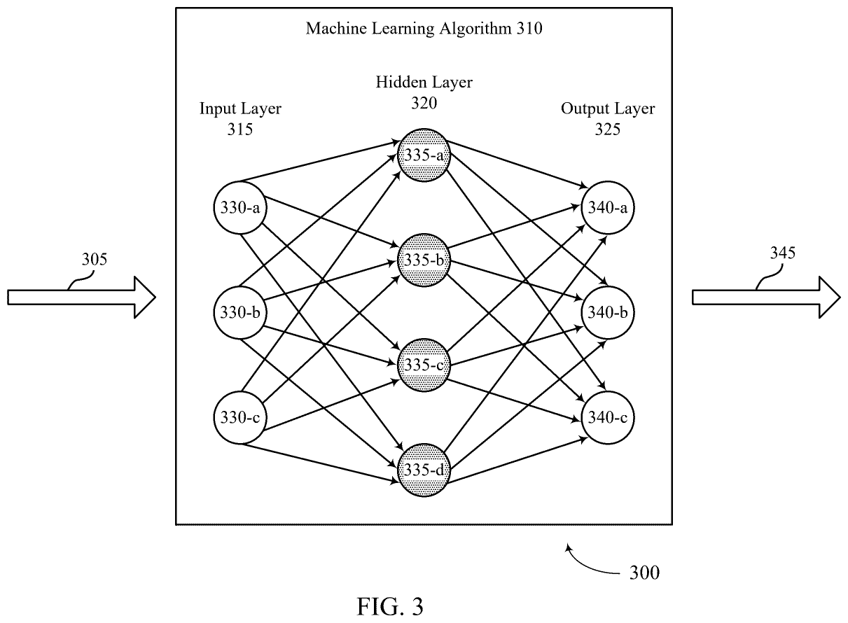

FIG. 3 shows an example of an ML process 300 that supports AI-based LCM signaling in accordance with one or more aspects of the present disclosure. The ML process 300 may be implemented at a network entity 105, or a UE 115, or both as described with reference to FIGS. 1 through 2.

The ML process 300 may include an ML algorithm 310. As illustrated, the ML algorithm 310 may be an example of a neural network, such as a feed forward (FF) or deep feed forward (DFF) neural network, a recurrent neural network (RNN), a long/short term memory (LSTM) neural network, or any other type of neural network. However, any other ML algorithms may be supported. For example, the ML algorithm 310 may implement a nearest neighbor algorithm, a linear regression algorithm, a Naïve Bayes algorithm, a random forest algorithm, or any other ML algorithm. Furthermore, the ML process 300 may involve supervised learning, unsupervised learning, semi-supervised learning, reinforcement learning, or any combination thereof.

The ML algorithm 310 may include an input layer 315, one or more hidden layers 320, and an output layer 325. In a fully connected neural network with one hidden layer 320, each hidden layer node 335 may receive a value from each input layer node 330 as input, where each input may be weighted. These neural network weights may be based on a cost function that is revised during training of the ML algorithm 310. Similarly, each output layer node 340 may receive a value from each hidden layer node 335 as input, where the inputs are weighted. If post-deployment training (e.g., online training) is supported, memory may be allocated to store errors and/or gradients for reverse matrix multiplication. These errors and/or gradients may support updating the ML algorithm 310 based on output feedback. Training the ML algorithm 310 may support computation of the weights (e.g., connecting the input layer nodes 330 to the hidden layer nodes 335 and the hidden layer nodes 335 to the output layer nodes 340) to map an input pattern to a desired output outcome. This training may result in a device-specific ML algorithm 310 based on the historic application data and data transfer for a specific network entity 105 or UE 115.

In some examples, input values 305 may be sent to the ML algorithm 310 for processing. In some examples, preprocessing may be performed according to a sequence of operations on the input values 305 such that the input values 305 may be in a format that is compatible with the ML algorithm 310. The input values 305 may be converted into a set of k input layer nodes 330 at the input layer 315. In some cases, different measurements may be input at different input layer nodes 330 of the input layer 315. Some input layer nodes 330 may be assigned default values (e.g., values of 0) if the quantity of input layer nodes 330 exceeds the quantity of inputs corresponding to the input values 305. As illustrated, the input layer 315 may include three input layer nodes 330-a, 330-b, and 330-c. However, it is to be understood that the input layer 315 may include any quantity of input layer nodes 330 (e.g., 20 input nodes).

The ML algorithm 310 may convert the input layer 315 to a hidden layer 320 based on a quantity of input-to-hidden weights between the k input layer nodes 330 and the n hidden layer nodes 335. The ML algorithm 310 may include any quantity of hidden layers 320 as intermediate steps between the input layer 315 and the output layer 325. Additionally, each hidden layer 320 may include any quantity of nodes. For example, as illustrated, the hidden layer 320 may include four hidden layer nodes 335-a, 335-b, 335-c, and 335-d. However, it is to be understood that the hidden layer 320 may include any quantity of hidden layer nodes 335 (e.g., 10 input nodes). In a fully connected neural network, each node in a layer may be based on each node in the previous layer. For example, the value of hidden layer node 335-a may be based on the values of input layer nodes 330-a, 330-b, and 330-c (e.g., with different weights applied to each node value).

The ML algorithm 310 may determine values for the output layer nodes 340 of the output layer 325 following one or more hidden layers3. For example, the ML algorithm 310 may convert the hidden layer 320 to the output layer 325 based on a quantity of hidden-to-output weights between the n hidden layer nodes 335 and the m output layer nodes 340. In some cases, n=m. Each output layer node 340 may correspond to a different output value 345 of the ML algorithm 310. As illustrated, the ML algorithm 310 may include three output layer nodes 340-a, 340-b, and 340-c, supporting three different threshold values. However, it is to be understood that the output layer 325 may include any quantity of output layer nodes 340. In some examples, post-processing may be performed on the output values 345 according to a sequence of operations such that the output values 345 may be in a format that is compatible with reporting the output values 345.

In some examples, the ML algorithm 310 may be used to predict beam measurements (e.g., RSPR, SINR, or CIR) for a first set of beams (set A) based on measurements (e.g., RSPR, SINR, or CIR) for a second set of beams (set B). In some examples, the ML algorithm 310 may be used to generate layer 3 beam measurements based on layer 1 beam measurements. In some examples, the ML algorithm 310 may be used to predict radio link failure, handover failure, or beam failure.

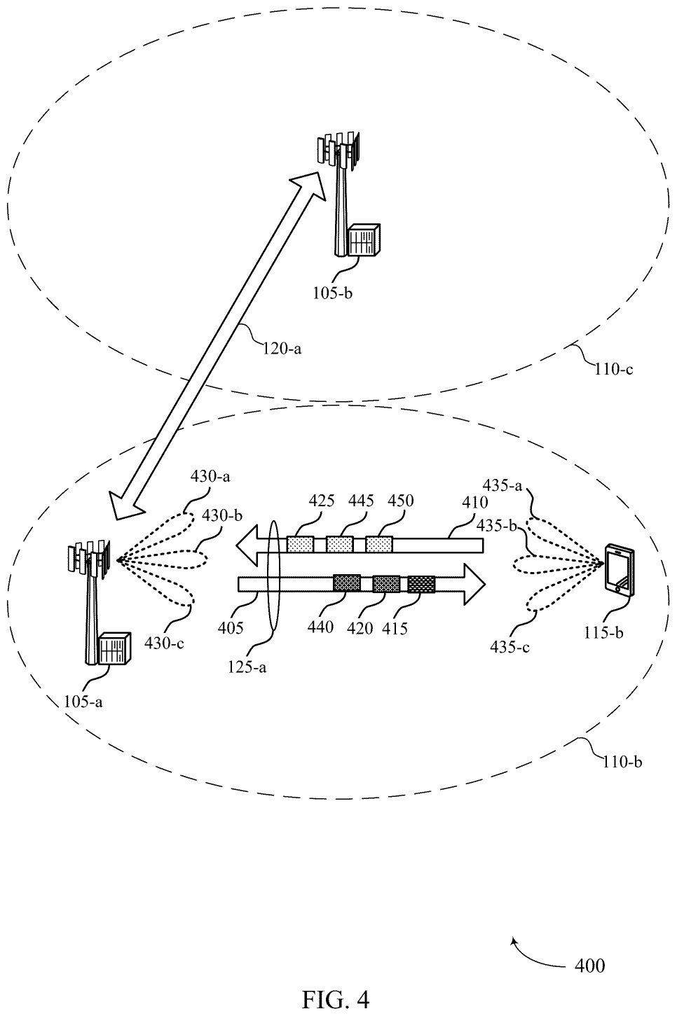

FIG. 4 shows an example of a wireless communications system 400 that supports AI-based LCM signaling in accordance with one or more aspects of the present disclosure. The wireless communications system 400 may implement or may be implemented by aspects of the wireless communications system 100, the network architecture 200, or the ML process 300. For example, the wireless communications system 400 may include a UE 115-b, which may be an example of a UE 115 as described herein. The wireless communications system 400 may include a network entity 105-a and a network entity 105-b, which may be examples of a network entity 105 as described herein. The network entity 105-a may be associated with a coverage area 110-b, and the network entity 105-a may be associated with a coverage area 110-c. The UE 115-b may be inside of the coverage area 110-b.

The UE 115-b may communicate with the network entity 105-a using a communication link 125-a. The communication link 125-a may be an example of an NR or LTE link between the UE 115-b and the network entity 105-a. The communication link 125-a may include a bi-directional link that enable both uplink and downlink communications. For example, the UE 115-b may transmit uplink signals 405 (e.g., uplink transmissions), such as uplink control signals or uplink data signals, to the network entity 105-a using the communication link 125-a and the network entity 105-a may transmit downlink signals 410 (e.g., downlink transmissions), such as downlink control signals or downlink data signals, to the UE 115-b using the communication link 125-a. The network entity 105-a may communicate with the network entity 105-b using a backhaul communication link 120-a.

The network entity 105-a may transmit a set of reference signals 420 (e.g., CSI-RSs or SSBs) to the UE 115-b. The network entity 105-a may use beamforming techniques to transmit the set of reference signals 420 via a set of transmit beams 430 (e.g., a beam 430-a, a beam 430-b, and a beam 430-c as shown in FIG. 4). The UE 115-b may receive the set of reference signals 420 via a set of receive beams 435 (e.g., a beam 435-a, a beam 435-b, and a beam 435-c as shown in FIG. 4) at the UE 115-b that correspond to the set of transmit beams 430. The UE 115-b may transmit a report message 425 based on the set of reference signals 420. For example, the report message 425 may be a CSI report and/or may include one or more beam measurements and/or beam predictions based on the set of reference signals 420.

The UE 115-b may support AI/ML functionalities. For example, the UE 115-b may support one or more AI/ML functionalities for optimizing the wireless communications systems (e.g., efficient network energy saving, beam management, load balancing, and mobility optimization). LCM mechanisms may be used to control the AI/ML functionalities of the UE 115-b. For example, LCM mechanisms may include LCM decisions by the network (e.g., the network entity 105-a) or LCM decisions by the UE 115-b. For example, LCM decisions by the network may be network initiated or may be initiated by the UE 115-b and requested to the network (e.g., in a request message 450). The network entity 105-a may transmit an LCM control message 440 that indicates an LCM decision for the UE 115-b (e.g., a configuration for one or more AI/ML functionalities of the UE 115-b). In some examples, LCM decisions by the UE 115-b may be event triggered as configured by the network (e.g., in control information 415), where the decision of the UE 115-b may be reported to the network entity 105-a (e.g., in a report message 445). In some examples, LCM decisions by the UE 115-b may be autonomous, and the decision of the UE 115-b may be reported to the network entity 105-a (e.g., in a report message 445). In some examples, LCM decisions by the UE 115-b may be autonomous, and the LCM decisions by the UE 115-b may not be reported to the network entity 105-a.

In some examples, LCM decisions may be made via a network-initiated, network-decided method. For example, the network entity 105-a may transmit the control information 415 that may include a configuration associated with monitoring of one or more AI/ML functionalities (e.g., measurement and/or reporting configurations). The UE 115-b may monitor the one or more AI/ML functionalities (.g., may perform one or more measurements) in accordance with the configuration, and may transmit the report message 445 indicating the measurements. The network entity 105-a may make an LCM decision for one or more of the AI/ML functionalities based on the measurements, and the network entity 105-a may transmit an LCM control message 440 that indicates the LCM decision to the UE 115-b.

In some examples, LCM decisions may be made via a network-decided, UE-initiated method. For example, the network entity 105-a may transmit the control information 415 that may include a configuration associated with monitoring of one or more AI/ML functionalities (e.g., measurement and/or reporting configurations). The UE 115-b may monitor the one or more AI/ML functionalities (e.g., may perform one or more measurements) in accordance with the configuration, and may make an LCM decision for one or more of the AI/ML functionalities based on the measurements. The UE 115-b may transmit the request message 450 that indicates the requested LCM action. In response, the network entity 105-a may transmit the LCM control message 440 that indicates whether the network accepts or rejects the requested LCM action. In some examples, the LCM control message 440 may indicate additional information (e.g., configuration information) for the AI/ML functionality or functionalities.

In some examples, LCM decisions may be made via a UE-decided, event triggered method. For example, the network entity 105-a may transmit the control information 415 that may include a configuration associated with monitoring of one or more AI/ML functionalities (e.g., measurement and/or reporting configurations). The configuration may indicate conditions for triggering an LCM action. The UE 115-b may monitor the one or more AI/ML functionalities (e.g., may perform one or more measurements) in accordance with the configuration, and may trigger an LCM action for one or more of the AI/ML functionalities based on the measurements satisfying the event triggering conditions. In some examples, the UE 115-b may transmit a report message 445 indicating the LCM action and/or information about the AI/ML functionality or functionalities for which the LCM action was performed.

In some examples, LCM decisions may be made via a UE autonomous method. In some examples, the network entity 105-a may transmit the control information 415 that may include a configuration associated with monitoring of one or more AI/ML functionalities (e.g., measurement and/or reporting configurations). The UE 115-b may monitor the one or more AI/ML functionalities (e.g., may perform one or more measurements) in accordance with the configuration, and may make an LCM decision for one or more of the AI/ML functionalities based on the measurements. The UE 115-b may perform an LCM action for the one or more of the AI/ML functionalities based on the LCM decision. In some examples, the UE 115-b may transmit a report message 445 indicating the LCM action and/or information about the AI/ML functionality or functionalities for which the LCM action was performed. In some examples, the UE 115-b may not transmit a report message 445 indicating the LCM action, and such actions may be transparent to the network.

The UE 115-b-b may have been previously within the coverage area 110-c of the network entity 105-b, and accordingly the UE 115-b may have previously been served by the network entity 105-b. LCM may involve parameterization, including consistency between training and inference, and localization (e.g., translating input/output to local indices). In single-network entity cases, such inferences may be performed frequently by a single serving cell, and therefore performance monitoring may be performed efficiently (e.g., as a large quantity of samples may be collected for monitoring). Further, action based on inaccurate predictions may result in performance degradation, but may not cause failures such as radio link failure, beam failure detection, and handover failure.

In mobility cases, such inferences may be performed occasionally (e.g., for handover purposes). For example, if serving cell quality is good, the measurements on neighboring cells or frequencies may not be performed by the UE 115-b. In mobility cases, actions based on inaccurate AI/ML model predictions by the UE 115-b may result in failures such as radio link failure, beam failure detection, and handover failure. For layer 1 use cases, when a UE 115-b is connected to a serving cell (e.g., the network entity 105-a), the serving cell may obtain KPIs from the UE 115-b for AI/ML functionality or functionalities of the UE 115-b, as described herein, and may perform LCM actions based on the KPIs. For example, when the UE 115-b is connected to a serving cell, the UE 115-b may be provided a cell radio network temporary identifier (C-RNTI). The serving cell may map performance KPIs and LCM actions with the C-RNTI for the UE 115-b (e.g., the identity of the UE 115-b). Thus, in some cases, for layer 1 AI/ML functionalities, the serving cell may not be dependent on performance metrics from other cells or network entities.

For some AI/ML functionalities, such as cell level or beam predictions, the serving network entity 105-a may depend on performance KPIs from previous cells to make LCM decisions. For example, the serving network entity 105-a may make inefficient LCM decisions if the KPIs for a given AI/ML functionality are collected from only the time when the UE 115-b is connected to the serving cell (e.g., either directly from the UE 115-b or via neighboring cells). For example, KPI samples from prior serving cells may not be available for the serving cell when the serving cell is making LCM decisions. For example, UE IDs may be temporary for mobility purposes, and accordingly, after one or more handovers or RRC state transitions, a serving network entity 105-a may not uniquely identify a UE 115-b while the UE 115-b was connected to another network entity (e.g., the network entity 105-b). In such mobility cases, tracking KPIs for AI/ML functionalities for a given UE (e.g., the UE 115-b) may be difficult for network-decided and network-initiated LCM methods, network-decided and UE-initiated LCM methods, and UE-decided event triggered LCM decisions (e.g., events triggered by the network) as the UE 115-b moves across cells. For example, as the identity of the UE 115-b (e.g., the C-RNTI) may be temporary at the network entity 105-a, the network entity 105-a may not uniquely identify the UE 115-b when the UE 115-b was connected to other network entities 105. For example, if the UE 115-b performed poorly for a given AI/ML functionality when connected to the network entity 105-b, the network entity 105-a may not identify the past poor performance of the UE 115-b. Accordingly, the network entity 105-a may enable the UE 115-b to perform the given AI/ML functionality even if the UE 115-b previously performed poorly for that AI/ML functionality, thereby reducing system performance. In some examples, vendor-based information for UEs 115 may not be exposed to the RAN, and accordingly, vendor-based LCM for AI functionalities of a UE 115 may not be feasible.

In such mobility cases, where the UE 115-b may move between coverage areas 110 and accordingly may be served by multiple network entities 105 across time, the UE 115-b or the network entity 105-a may monitor performance parameters in mobility cases for LCM for AI/ML functionalities in accordance with techniques described herein.

In UE-based LCM for AI functionalities, the UE 115-b may monitor and track KPIs for AI functionalities of the UE 115-b across network entities 105 (e.g., across serving cells). In some examples, the UE 115-b may autonomously make LCM decisions for AI functionalities based on the performance indicators (e.g., KPIs associated with the corresponding AI functionalities). In some examples, the UE 115-b may transmit an LCM request message to the network based on the performance, and the network entity 105-a may transmit an LCM control message to the UE 115-b based on the LCM request. In some examples, the UE 115-b may transmit an indication of the performance indicators (e.g., historical KPIs of the UE 115-b across network entities 105), and the network entity 105-a may make an LCM decision for AI functionalities of the UE 115-b based on the indicated performance indicators. The network entity 105-a may transmit a corresponding LCM control message to the UE 115-b that indicates the LCM decision. In such examples, the UE 115-b may perform an LCM action based on the LCM control message.

In network-based LCM for AI functionalities, the serving network entity 105-b may obtain information regarding performance indicators for the UE 115-b from another network entity. When the UE 115-b reports an AI functionality, the network entity 105-a may obtain the information regarding UE 115-b performance for that AI functionality from the other network entity and may make an LCM decision based on the obtained information. The network entity 105-a may transmit an LCM control message to the UE 115-b based on the LCM decision. In such examples, the UE 115-b may perform an LCM action based on the LCM control message.

For example, network-based LCM methods may involve model ID based LCM. For example, for a given AI/ML functionality, a logical model ID may be used to track KPIs of UEs 115 associated with the logical model ID. Network entities (e.g., neighbor network entities, network entities within a RAN based notification area (RNA), or within a target area) may uniquely identify a logical model ID associated with a given AI/ML functionality for a UE type. The network entities 105 may not identify the vendor or specific UE identity, as the UE 115-b may be associated with the logical model ID. The network entities 105 may track and store the KPIs for the logical model ID, and the network entities 105 may provide relevant information for parameterization. The network entities may exchange the KPIs for the model ID with neighbor network entities 105 (e.g., using access and mobility information or other signaling types (e.g., F1, Xn, or Ng signaling)) and may update the model ID performance information based on the exchanged information with other network entities 105.

As another example, network-based LCM methods may involve an OAM based solution. The OAM entity may track AI/ML functionality performance for a given UE (e.g., the UE 115-b) across multiple cells, network entities 105, RNAs, or tracking areas. The serving network entity 105-a may configure an AI/ML functionality for the UE 115-b based on a request from the OAM entity (e.g., or based on procedure defined for the serving network entity 105 to check AI/ML functionality for the UE 115-b with the OAM entity). The serving network entity 105-a or the OAM entity may provide information for parameterization for configuring the AI/ML functionality for the UE 115-b.

As another example, network-based LCM methods may involve a central entity (e.g., a NWDAF, UDM, or UE hosted application function) based method. The central entity may track AI/ML functionality performance for a given UE (e.g., the UE 115-b) across multiple cells, network entities 105, RNAs, or tracking areas. The serving network entity 105-a may check the KPIs for the AI/ML functionality for the UE 115-b before providing a configuration for the AI/ML functionality for the UE 115-b. The serving network entity 105-a or the central entity may provide information for parameterization for configuring the AI/ML functionality for the UE 115-b.

In some examples, information for parameterization may include information for consistency between training and inference. For example, such information may include a model ID or dataset ID representing additional conditions at the UE 115-b or the network entity 105-a. Additional information may include a layout, which may be provided by the network or derived by the UE 115-b or UE vendors, where the layout may include topological information (e.g., the quantity of neighboring cells), standalone (SA) or non-SA (e.g., whether the UEs are configured with non-SA), band or band combination information (e.g., the quantity of supported bands and band combination information), carrier aggregation (CA) (e.g., whether CA is supported and the quantity of supported cells), or transmission reception point (TRP) information (e.g., the quantity of TRPs). In some examples, information for parameterization may include information for localization (e.g., translating input/output information to local indices). For example, such information for localization may include PCI and beam index information or mapping information to map PCI and beams with the network entity configuration (e.g., for training purposes).

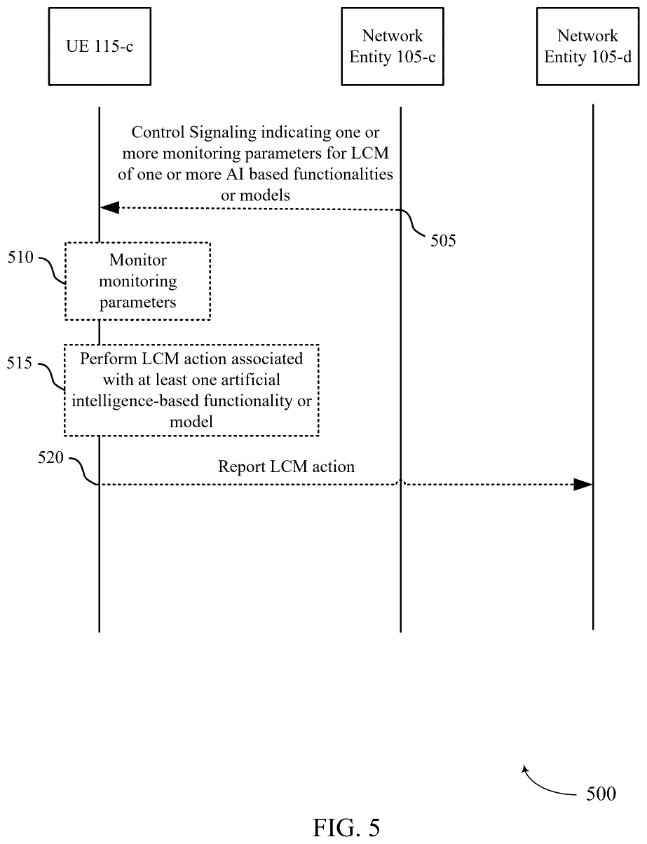

FIG. 5 shows an example of a process flow 500 that supports AI-based LCM signaling in accordance with one or more aspects of the present disclosure. The process flow 500 may implement or may be implemented by aspects of the wireless communications system 100, the network architecture 200, the ML process 300, or the wireless communications system 400. For example, the process flow 500 may include a UE 115-c, which may be an example of a UE 115 as described herein. The process flow 500 may also include a network entity 105-c and a network entity 105-d, which may be example of network entities 105 as described herein. In the following description of the process flow 500, the operations between the network entity 105-c, the network entity 105-d, and the UE 115-c may be transmitted in a different order than the example order shown, or the operations performed by the network entity 105-c, the network entity 105-d, and the UE 115-c may be performed in different orders or at different times. Some operations may also be omitted from the process flow 500, and other operations may be added to the process flow 500.

At 505, the UE 115-c may receive control signaling from the network entity 105-c, when the network entity 105-c is the serving network entity for the UE 115-c. The control signaling may indicate one or more monitoring parameters (e.g., KPIs to measure, monitor, and/or track) associated with LCM of one or more AI/ML functionalities of the UE 115-c.

At 510, the UE 115-c may monitor the one or more LCM monitoring parameters. After receiving the control signaling at 505, the UE 115-c may connect to the network entity 105-d. For example, subsequent to receiving the control signaling at 505, the network entity 105-d may become the serving network entity for the UE 115-c.

At 515, the UE 115-c may perform an LCM action for at least one AI/ML functionality of the one or more AI/ML functionalities of the UE 115-c based on the monitoring at 510.

In some examples, at 520, the UE 115-c may transmit a report message to the network entity 105-d indicating the LCM action at 515.

In some examples, the one or more LCM monitoring parameters may include an accuracy or recall of an AI or ML prediction. For example, for layer 3 beam or cell measurement predictions, the accuracy of the prediction may be a layer 1 or layer 3 prediction accuracy, a minimum mean square error (MMSE), or an outcome of the prediction. As another example, for radio link failure predictions, handover failure predictions, or beam predictions, the one or more monitoring parameters may include timing information or an outcome of the predictions (e.g., whether the predictions resulted in a success or failure), upon which the network (e.g., the serving network entity 105 for the UE 115-c at the time) may provide feedback to the UE 115-c. Examples of the timing information may include: whether a predicted handover time is the same as an actual handover time, whether the predicted handover time is within some duration or a time window of the actual handover time, a time difference between the predicted handover time and the actual handover time, whether a predicted radio link failure time is the same as an actual radio link failure time, whether the predicted radio link failure time is within some duration or a time window of the radio link failure time, the time difference between the predicted radio link failure time and the actual radio link failure time, or any combination thereof. In some examples, the one or more LCM monitoring parameters may include a rate of successful and failed predictions. For example, for radio link failure predictions, handover failure predictions, or beam predictions, the rate of successful and failed predictions may be the failure and success rate for radio link failure predictions, handover failure predictions, or beam predictions, upon which the network may provide feedback to the UE 115-c. As another example, for measurement events or handover execution predictions, the rate of successful and failed predictions may be based on the success and failure rate of the predictions.

In some examples, the LCM action performed at 515 may include activating an AI/ML functionality, deactivating the AI/ML functionality, switching the AI/ML functionality to a different configuration, switching to a fallback configuration for the AI/ML functionality, reconfiguring the AI/ML functionality, or switching to a non-AI-based function. In some examples, the LCM action performed at 515 may be based on the monitored performance of the AI/ML functionality, an area in which the UE 115-c is located (e.g., a cell group, RNA, or target area), carrier frequencies (e.g., FR1 or FR2), the operating band or band combination, whether the UE 115-c operates in SA or non-SA mode, whether counters are satisfied (e.g., for radio link failure, handover failure, secondary cell group (SCG) failure, quantity of RACH attempts, Qin, Qout) or whether network provided counters are satisfied. In some examples, the serving network entity 105 (e.g., the network entity 105-c or the network entity 105-d) may provide a conditional configuration for an AI/ML functionality, for example, based on detectable conditions at the network entity 105-d or the UE 115-c.

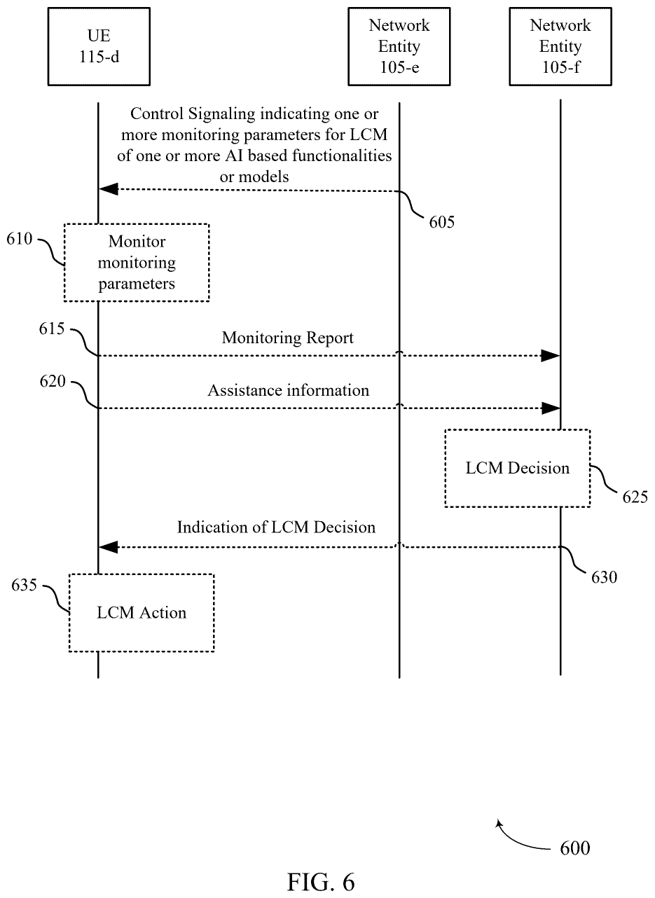

FIG. 6 shows an example of a process flow 600 that supports AI-based LCM signaling in accordance with one or more aspects of the present disclosure. The process flow 600 may implement or may be implemented by aspects of the wireless communications system 100, the network architecture 200, the ML process 300, or the wireless communications system 400. For example, the process flow 600 may include a UE 115-d, which may be an example of a UE 115 as described herein. The process flow 600 may also include a network entity 105-e and a network entity 105-f, which may be examples of network entities 105 as described herein. In the following description of the process flow 600, the operations between the network entity 105-e, the network entity 105-f, and the UE 115-d may be transmitted in a different order than the example order shown, or the operations performed by the network entity 105-e, the network entity 105-f, and the UE 115-d may be performed in different orders or at different times. Some operations may also be omitted from the process flow 600, and other operations may be added to the process flow 600.

At 605, the UE 115-d may receive control signaling from the network entity 105-e, when the network entity 105-e is the serving network entity for the UE 115-d. The control signaling may indicate one or more monitoring parameters (e.g., KPIs to measure, monitor, and/or track) associated with LCM of one or more AI/ML functionalities of the UE 115-d. For example, the network entity 105-e may configure the UE 115-d to report previous performance metrics (e.g., KPIs). In some examples, historical performance may be configured to be reported per band, SA, or non-SA mode.

At 610, the UE 115-d may monitor the one or more LCM monitoring parameters. After receiving the control signaling at 605, the UE 115-d may connect to the network entity 105-f. For example, subsequent to receiving the control signaling at 605, the network entity 105-f may become the serving network entity for the UE 115-d.

At 615, the UE 115-d may transmit a report message to the network entity 105-f that indicates the KPIs measured by the UE 115-d in accordance with the control signaling at 605.

At 620, the network entity 105-f may make an LCM decision for at least one AI/ML functionality of the one or more AI/ML functionalities of the UE 115-d based on the report message (e.g., based on the indicated KPIs). In some examples, at 625, the UE 115-d may transmit assistance information indicating a preferred LCM action for one or more AI/ML functionalities of the UE 115-d, and the network entity 105-f may make the LCM decision based on the indicated preferred LCM action.

At 630, the network entity 105-f may transmit an LCM control message indicating the LCM decision (e.g., an LCM action for the one or more AI/ML functionalities of the UE 115-d such as a configuration for the one or more AI/ML functionalities). For example, the LCM action may include activating an AI/ML functionality, deactivating the AI/ML functionality, switching the AI/ML functionality to a different configuration, switching to a fallback configuration for the AI/ML functionality, reconfiguring the AI/ML functionality, or switching to a non-AI-based function.

At 635, the UE 115-d may perform the indicated LCM action.

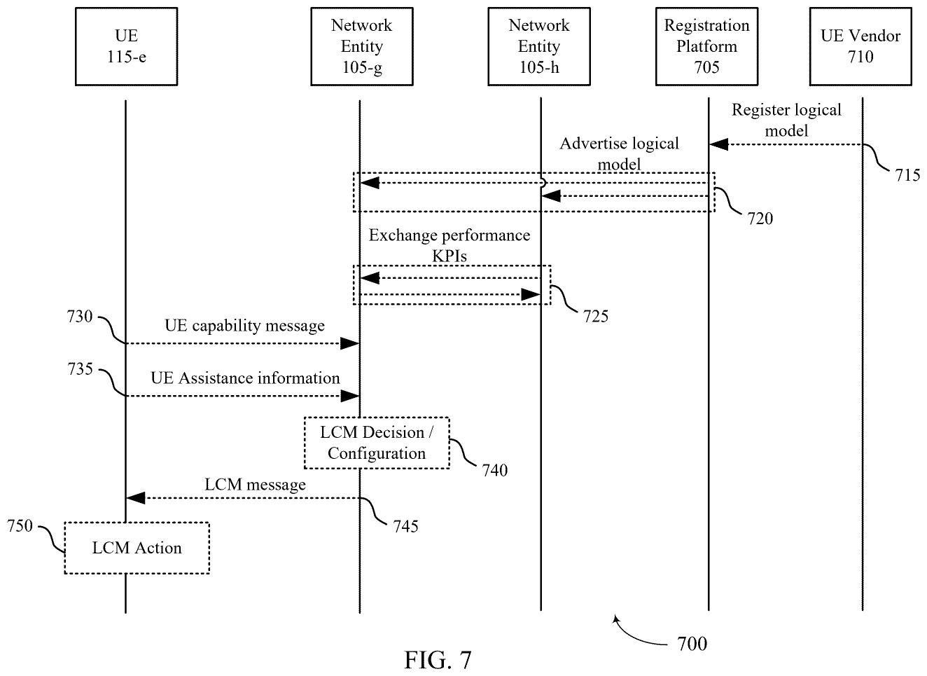

FIG. 7 shows an example of a process flow 700 that supports AI-based LCM signaling in accordance with one or more aspects of the present disclosure. The process flow 700 may implement or may be implemented by aspects of the wireless communications system 100, the network architecture 200, the ML process 300, or the wireless communications system 400. For example, the process flow 700 may include a UE 115-e, which may be an example of a UE 115 as described herein. The process flow 700 may also include a network entity 105-g and a network entity 105-h, which may be examples of network entities 105 as described herein. The process flow 700 may also include a registration platform 705 and a UE vendor 710. In the following description of the process flow 700, the operations between the network entity 105-g, the network entity 105-h, UE 115-e, the registration platform 705, and the UE vendor 710 may be transmitted in a different order than the example order shown, or the operations performed by the network entity 105-g, the network entity 105-h, UE 115-d, the registration platform 705, and the UE vendor 710 may be performed in different orders or at different times. Some operations may also be omitted from the process flow 700, and other operations may be added to the process flow 700.

At 715, the UE vendor 710 may register a logical model for a UE type associated with (e.g., manufactured by) the UE vendor 710 at the registration platform 705. For example, the UE vendor 710 may register different logical models for different UE types or implementations. Different UE vendors may use the same registration platform 705. The logical model (e.g., identified at the registration platform by a logical model ID) may be used for tracking and exchanging performance of AI/ML functionalities for the UE type or UE implementations associated with the logical model across network entities 105 (e.g., at least across neighboring network entities 105 such as the network entity 105-g and the network entity 105-h).

In some examples, at 720, the registration platform 705 may advertise the registered logical models to the network entities 105 (e.g., the network entity 105-g and the network entity 105-h).

In some examples, in response to reception of the logical model, at 725 the network entity 105-g may exchange KPIs with neighboring network entities (e.g., the network entity 105-h). For example, the network entity 105-g may request performance metrics (e.g., KPIs) for the logical model ID. In some examples, a UE vendor 710 may perform similar procedures to update an existing logical model as to initially register a logical model. For example, upon receiving an update to a logical model from the UE vendor 710, the registration platform may advertise the update to the logical model to the network entities 105, and the network entities 105 may reset performance metrics based on the update.

At 730, the network entity 105-g (e.g., the serving network entity for the UE 115-e) may receive capability information for AI/ML functionalities for the UE 115-e. For example, the UE 115-e may indicate the logical model ID associated with the UE 115-e. As another example, the UE 115-e may indicate the UE type of the UE 115-e, and the network entity 105-g may identify the logical model ID associated with the UE type. As another example, the UE 115-e may indicate an AI/ML functionality of the UE 115-e, and the network entity 105-g may identify the logical model ID associated with the indicated AI/ML functionality of the UE 115-e.

At 740, the network entity 105-g may make an LCM decision for at least one AI/ML functionality of the UE 115-e based on the logical model and the retrieved KPIs for the logical model. In some examples, at 735, the UE 115-e may transmit assistance information that indicates a preferred LCM action for one or more AI/ML functionalities of the UE 115-e, and the network entity 105-g may make the LCM decision based on the indicated preferred LCM action.

At 745, the network entity 105-g may transmit an LCM control message indicating the LCM decision (e.g., an LCM action for the at least one AI/ML functionalities of the UE 115-e such as a configuration for the one or more AI/ML functionalities). For example, the LCM action may include activating an AI/ML functionality, deactivating the AI/ML functionality, switching the AI/ML functionality to a different configuration, switching to a fallback configuration for the AI/ML functionality, reconfiguring the AI/ML functionality, or switching to a non-AI-based function.

At 750, the UE 115-e may perform the indicated LCM action.

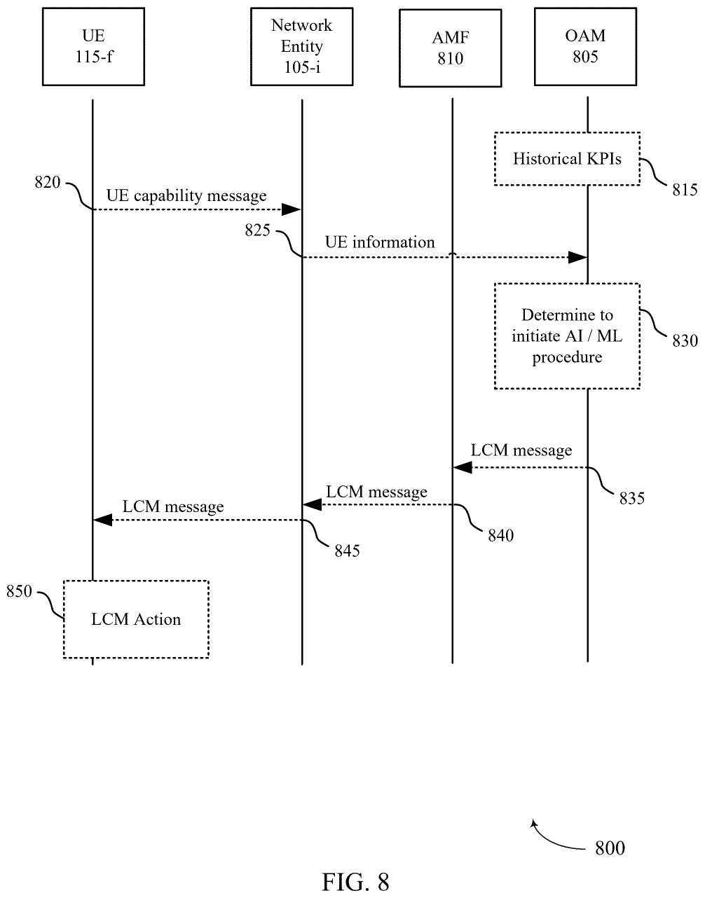

FIG. 8 shows an example of a process flow 800 that supports AI-based LCM signaling in accordance with one or more aspects of the present disclosure. The process flow 800 may implement or may be implemented by aspects of the wireless communications system 100, the network architecture 200, the ML process 300, or the wireless communications system 400. For example, the process flow 800 may include a UE 115-f, which may be an example of a UE 115 as described herein. The process flow 800 may also include a network entity 105-i, which may be an example of a network entity 105 as described herein. The process flow 800 may also include an OAM entity 805 and an AMF 810. In the following description of the process flow 800, the operations between the network entity 105-i, the UE 115-f, the OAM entity 805, and the AMF 810 may be transmitted in a different order than the example order shown, or the operations performed by the network entity 105-i, the UE 115-f, the OAM entity 805, and the AMF 810 may be performed in different orders or at different times. Some operations may also be omitted from the process flow 800, and other operations may be added to the process flow 800.

At 815, the OAM entity 805 may store historical KPIs associated with each AI/ML functionality of the UE 115-f. For example, the OAM entity 805 may receive indications of the KPIs for each AI/ML functionality of the UE 115-f from prior network entities 105 that the UE 115-f was served by (e.g., via the AMF 810).

At 820, the network entity 105-i (e.g., the serving network entity for the UE 115-f) may receive capability information for AI/ML functionalities for the UE 115-f. For example, the UE 115-f may transmit the capability information during a random access channel (RACH) procedure or in RRC signaling.

At 825, the network entity 105-i may transmit UE information indicating the identity of the UE 115-f to the OAM entity 805.

In some examples, at 830, the OAM entity 805 may determine, based on the historical KPIs for the UE 115-f and/or based on the information that the UE 115-f is connected to the network entity 105-i, to initiate an AI/ML procedure at the UE 115-f. For example, the AI/ML procedure may be an AI/ML based mobility procedure.

At 835, the OAM entity 805 may transmit an LCM control message to the AMF 810 that indicates for the UE 115-f to perform the AI/ML procedure. For example, the LCM control message may indicate the UE ID for the UE 115-f, the AI/ML functionality or functionalities to configure, and the configuration information for the AI/ML functionality or functionalities.

At 840, the AMF 810 may transmit an LCM control message to the network entity 105-i that indicates for the UE 115-f to perform the AI/ML procedure. For example, the LCM control message may indicate the UE ID for the UE 115-f, the AI/ML functionality or functionalities to configure, and the configuration information for the AI/ML functionality or functionalities.

At 845, the network entity 105-i may transmit an LCM control message to the UE 115-f that indicates for the UE 115-f to perform the AI/ML procedure. For example, the LCM control message may indicate the UE ID for the UE 115-f, the AI/ML functionality or functionalities to configure, and the configuration information for the AI/ML functionality or functionalities. For example, the LCM control message may indicate an LCM action for the UE 115-f, which LCM action may include activating an AI/ML functionality, deactivating the AI/ML functionality, switching the AI/ML functionality to a different configuration, switching to a fallback configuration for the AI/ML functionality, reconfiguring the AI/ML functionality, or switching to a non-AI-based function.

At 850, the UE 115-f may perform the indicated LCM action.

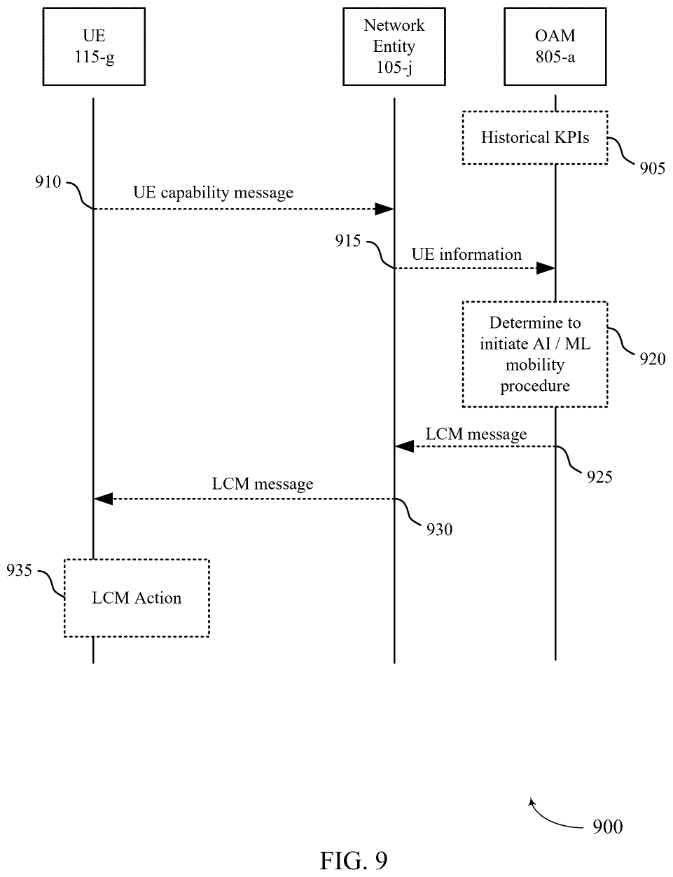

FIG. 9 shows an example of a process flow 900 that supports AI-based LCM signaling in accordance with one or more aspects of the present disclosure. The process flow 900 may implement or may be implemented by aspects of the wireless communications system 100, the network architecture 200, the ML process 300, or the wireless communications system 400. For example, the process flow 900 may include a UE 115-g, which may be an example of a UE 115 as described herein. The process flow 900 may also include a network entity 105-j, which may be an example of a network entity 105 as described herein. The process flow 900 may also include an OAM entity 805-a. In the following description of the process flow 900, the operations between the network entity 105-j, the UE 115-g, and the OAM entity 805-a may be transmitted in a different order than the example order shown, or the operations performed by between the network entity 105-j, the UE 115-g, and the OAM entity 805-a may be performed in different orders or at different times. Some operations may also be omitted from the process flow 900, and other operations may be added to the process flow 900.

At 905, the OAM entity 805-a may store historical KPIs associated with each AI/ML functionality of the UE 115-g. For example, the OAM entity 805-a may receive indications of the KPIs for each AI/ML functionality of the UE 115-g from prior network entities 105 that the UE 115-g was served by (e.g., via an AMF). The historical KPIs may be stored for each AI/ML functionality (e.g., a logical model ID may be associated with each AI/ML functionality in an area, such as per cell ID, per network entity, per RNA, or per target area).

At 910, the network entity 105-j (e.g., the serving network entity for the UE 115-g) may receive capability information for AI/ML functionalities for the UE 115-g. For example, the UE 115-g may transmit the capability information during a RACH procedure or in RRC signaling.

At 915, the network entity 105-j may transmit UE information indicating the identity of the UE 115-g to the OAM entity 805-a.

In some examples, at 920, the OAM entity 805-a may determine, based on the historical KPIs for the UE 115-g and/or based on the information that the UE 115-g is connected to the network entity 105-j, to initiate an AI/ML procedure at the UE 115-g. For example, the AI/ML procedure may be an AI/ML based mobility procedure.

At 925, the OAM entity 805-a may transmit an LCM control message to the network entity 105-j that indicates for the UE 115-g to perform the AI/ML procedure. For example, the LCM control message may indicate the UE ID for the UE 115-g, the AI/ML functionality or functionalities to configure, and the configuration information for the AI/ML functionality or functionalities.

At 930, the network entity 105-j may transmit an LCM control message to the UE 115-g that indicates for the UE 115-g to perform the AI/ML procedure. For example, the LCM control message may indicate the UE ID for the UE 115-g, the AI/ML functionality or functionalities to configure, and the configuration information for the AI/ML functionality or functionalities. For example, the LCM control message may indicate an LCM action for the UE 115-g, which LCM action may include activating an AI/ML functionality, deactivating the AI/ML functionality, switching the AI/ML functionality to a different configuration, switching to a fallback configuration for the AI/ML functionality, reconfiguring the AI/ML functionality, or switching to a non-AI-based function.

At 935, the UE 115-g may perform the indicated LCM action.

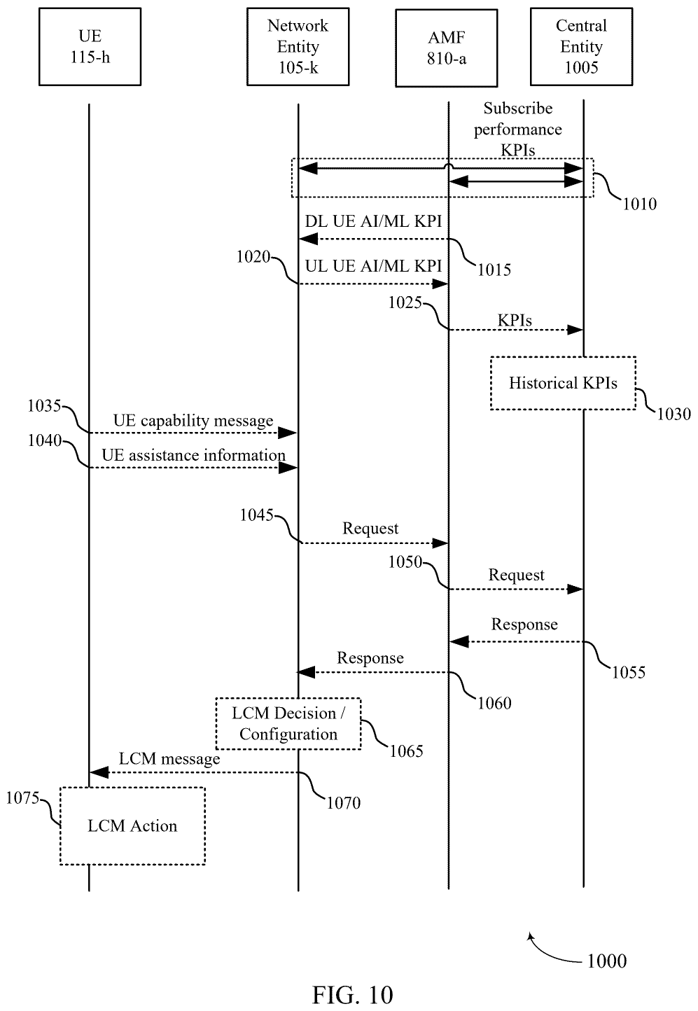

FIG. 10 shows an example of a process flow 1000 that supports AI-based LCM signaling in accordance with one or more aspects of the present disclosure. The process flow 1000 may implement or may be implemented by aspects of the wireless communications system 100, the network architecture 200, the ML process 300, or the wireless communications system 400. For example, the process flow 1000 may include a UE 115-h, which may be an example of a UE 115 as described herein. The process flow 1000 may also include a network entity 105-k, which may be an example of a network entity 105 as described herein. The process flow 1000 may also include an AMF 810-a and a central entity 1005. In the following description of the process flow 1000, the operations between the network entity 105-k, the UE 115-h, the AMF 810-a, and the central entity 1005 may be transmitted in a different order than the example order shown, or the operations performed by the network entity 105-k, the UE 115-h, the AMF 810-a, and the central entity 1005 may be performed in different orders or at different times. Some operations may also be omitted from the process flow 1000, and other operations may be added to the process flow 1000.

At 1010, the central entity 1005 may subscribe the AMF 810-a, and in turn the network entity 105-k, for performance KPIs for one or more UE AI/ML functionalities or logical model IDs. For example, the central entity 1005 may track KPIs for one or more AI/ML functionalities per UE based on the UE ID. In some examples, each AI/ML functionality may be associated with a respective logical model ID. In some examples, the central entity may be a NWDAF, an ADRF, or a UDM.

The network entity 105-k and the AMF 810-a may exchange tracked KPIs for AI/ML functionalities. For example, at 1015, the AMF 810-a may share downlink UE associated KPIs for one or more AI/ML functionalities for the UE 115-h. At 1020, the network entity 105-k may share uplink UE associated KPIs for one or more AI/ML functionalities for the UE 115-h. The network entity 105-k and the AMF 810-a may use similar mechanisms as NR positioning protocol A (NRPPa) to exchange the tracked KPIs.

At 1025, the AMF 810-a may send the tracked and/or retrieved KPIs to the central entity 1005.

Accordingly, at 1030, the central entity 1005 may store historical KPIs associated with each AI/ML functionality of the UE 115-h. The historical KPIs may be stored for each AI/ML functionality (e.g., a logical model ID may be associated with each AI/ML functionality in an area, such as per cell ID, per network entity, per RNA, or per target area).

In some examples, at 1035, the network entity 105-k (e.g., the serving network entity for the UE 115-h) may receive capability information for AI/ML functionalities for the UE 115-h. For example, the UE 115-h may transmit the capability information during a RACH procedure or in RRC signaling. In some examples, at 1040, the UE 115-h may transmit assistance information indicated a requested configuration for an AI/ML functionality.

At 1045, based on the capability information at 1035 or the assistance information at 1040, the network entity 105-k may transmit a request message to the AMF 810-a. For example, the request message may request historical KPIs associated with one or more AI/ML functionalities if the network entity 105-k received the capability message at 1035. As another example, the request message may request confirmation as to whether the requested configuration in the assistance information at 1040 is feasible.

At 1050, the AMF 810-a may transmit a request message to the central entity 1005 based on the request message at 1045.

At 1055, the central entity 1005 may provide a response message to the AMF 810-a for the request message at 1050. For example, the response message may include historical KPIs for the KPIs associated with one or more AI/ML functionalities if the request message requested the historical KPIs. As another example, the response message may include an indication of whether the requested configuration in the assistance information at 1040 is feasible.

At 1060, the AMF 810-a may transmit the response message to the network entity 105-k.

At 1065, the network entity 105-k may make an LCM decision based on the response message.

At 1070, the network entity 105-k may transmit an LCM control message indicating the LCM decision (e.g., an LCM action for the at least one AI/ML functionalities of the UE 115-h such as a configuration for the one or more AI/ML functionalities). For example, the LCM action may include activating an AI/ML functionality, deactivating the AI/ML functionality, switching the AI/ML functionality to a different configuration, switching to a fallback configuration for the AI/ML functionality, reconfiguring the AI/ML functionality, or switching to a non-AI-based function.

At 1075, the UE 115-h may perform the indicated LCM action.

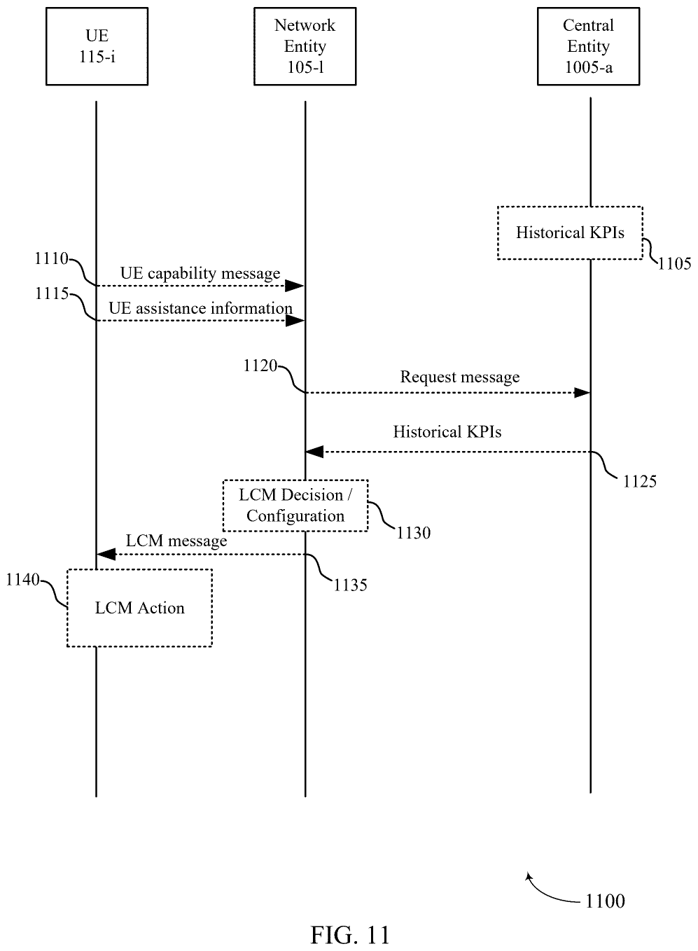

FIG. 11 shows an example of a process flow 1100 that supports AI-based LCM signaling in accordance with one or more aspects of the present disclosure. The process flow 1100 may implement or may be implemented by aspects of the wireless communications system 100, the network architecture 200, the ML process 300, or the wireless communications system 400. For example, the process flow 1100 may include a UE 115-i, which may be an example of a UE 115 as described herein. The process flow 1100 may also include a network entity 105-1, which may be an example of a network entity 105 as described herein. The process flow 1100 may also include a central entity 1005-a. In the following description of the process flow 1100, the operations between the network entity 105-1, the UE 115-i, and the central entity 1005-a may be transmitted in a different order than the example order shown, or the operations performed by between the network entity 105-1, the UE 115-i, and the central entity 1005-a may be performed in different orders or at different times. Some operations may also be omitted from the process flow 1100, and other operations may be added to the process flow 1100.

At 1105, the central entity 1005-a may store historical KPIs associated with each AI/ML functionality of the UE 115-i. The historical KPIs may be stored for each AI/ML functionality (e.g., a logical model ID may be associated with each AI/ML functionality in an area, such as per cell ID, per network entity, per RNA, or per target area).

In some examples, at 1110, the network entity 105-1 (e.g., the serving network entity for the UE 115-i) may receive capability information for AI/ML functionalities for the UE 115-i. For example, the UE 115-i may transmit the capability information during a RACH procedure or in RRC signaling. In some examples, at 1115, the UE 115-i may transmit assistance information indicated a requested configuration for an AI/ML functionality. The capability information at 1110 or the assistance information at 1115 may include encrypted identity information for the UE 115-i.

At 1120, based on the capability information at 1110 or the assistance information at 1115, the network entity 105-1 may transmit a request message to the central entity 1005-a that may include the encrypted identity information for the UE 115-i. For example, the request message may request historical KPIs associated with one or more AI/ML functionalities if the network entity 105-1 received the capability message at 1110. As another example, the request message may request confirmation as to whether the requested configuration in the assistance information at 1115 is feasible.

The central entity 1005-a may retrieve historical KPIs associated with the UE 115-i based on the encrypted ID. At 1125, the central entity 1005-a may provide a response message to the network entity 105-1 for the request message at 1120. For example, the response message may include historical KPIs for the KPIs associated with one or more AI/ML functionalities if the request message requested the historical KPIs. As another example, the response message may include an indication of whether the requested configuration in the assistance information at 1115 is feasible.

At 1130, the network entity 105-1 may make an LCM decision based on the response message.

At 1135, the network entity 105-1 may transmit an LCM control message indicating the LCM decision (e.g., an LCM action for the at least one AI/ML functionalities of the UE 115-i such as a configuration for the one or more AI/ML functionalities). For example, the LCM action may include activating an AI/ML functionality, deactivating the AI/ML functionality, switching the AI/ML functionality to a different configuration, switching to a fallback configuration for the AI/ML functionality, reconfiguring the AI/ML functionality, or switching to a non-AI-based function.

At 1140, the UE 115-i may perform the indicated LCM action.

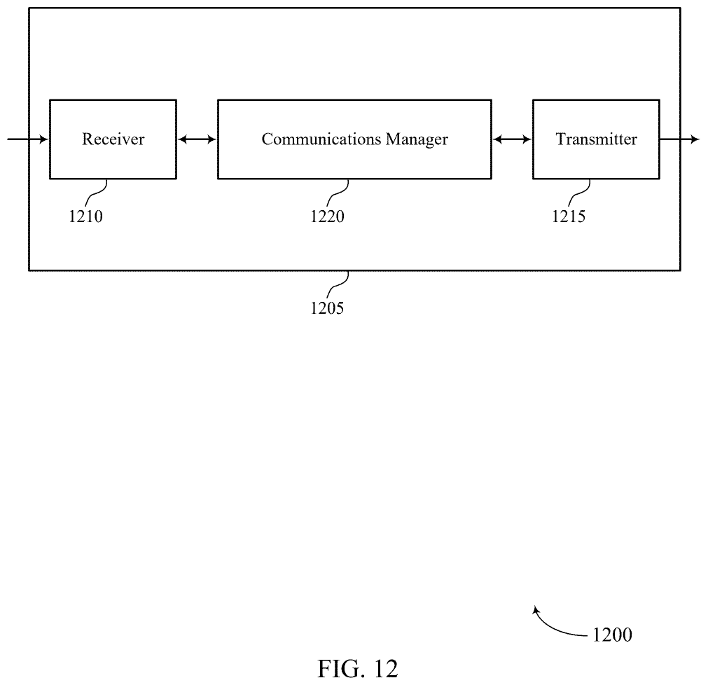

FIG. 12 shows a block diagram 1200 of a device 1205 that supports AI-based LCM signaling in accordance with one or more aspects of the present disclosure. The device 1205 may be an example of aspects of a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to AI-based LCM signaling). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to AI-based LCM signaling). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations or components thereof may be examples of means for performing various aspects of AI-based LCM signaling as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for receiving, from a first network entity, a control message including an indication of one or more monitoring parameters associated with LCM of one or more AI-based functionalities or models of the UE. The communications manager 1220 is capable of, configured to, or operable to support a means for performing, based on satisfaction of at least one monitoring parameter of the one or more monitoring parameters for a communication link associated with a second network entity, an LCM action associated with at least one AI-based functionality or model of the one or more AI-based functionalities.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for more efficient utilization of communication resources.

The communications manager 1220 may be an example of means for performing various aspects of LCM for UE AI/ML functionalities in mobility cases as described herein. The communications manager 1220, or its sub-components, may be implemented in hardware (e.g., in communications management circuitry). The circuitry may comprise of processor, DSP, an ASIC, an FPGA or other programmable logic device, discrete gate or transistor logic, discrete hardware components, or any combination thereof designed to perform the functions described in the present disclosure.

In another implementation, the communications manager 1220, or its sub-components, may be implemented in code (e.g., as communications management software or firmware) executed by a processor, or any combination thereof. If implemented in code executed by a processor, the functions of the communications manager 1220, or its sub-components may be executed by a general-purpose processor, a DSP, an ASIC, an FPGA or other programmable logic device.

In some examples, the communications manager 1220 may be configured to perform various operations (e.g., receiving, determining, transmitting) using or otherwise in cooperation with the receiver 1210, the transmitter 1215, or both.

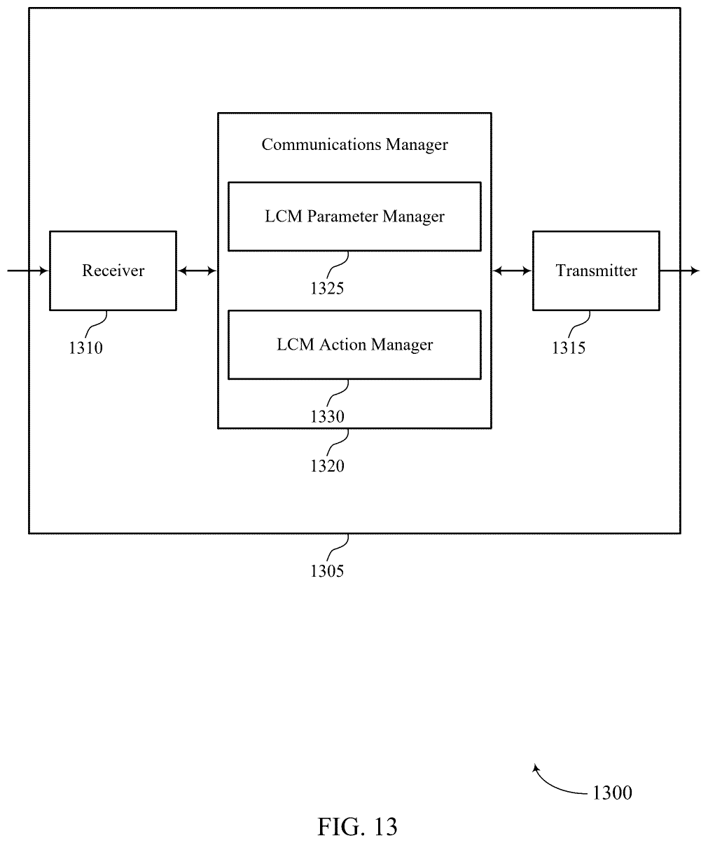

FIG. 13 shows a block diagram 1300 of a device 1305 that supports AI-based LCM signaling in accordance with one or more aspects of the present disclosure. The device 1305 may be an example of aspects of a device 1205 or a UE 115 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to AI-based LCM signaling). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to AI-based LCM signaling). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of AI-based LCM signaling as described herein. For example, the communications manager 1320 may include an LCM parameter manager 1325 an LCM action manager 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The LCM parameter manager 1325 is capable of, configured to, or operable to support a means for receiving, from a first network entity, a control message including an indication of one or more monitoring parameters associated with LCM of one or more AI-based functionalities or models of the UE. The LCM action manager 1330 is capable of, configured to, or operable to support a means for performing, based on satisfaction of at least one monitoring parameter of the one or more monitoring parameters for a communication link associated with a second network entity, an LCM action associated with at least one AI-based functionality or model of the one or more AI-based functionalities or models.

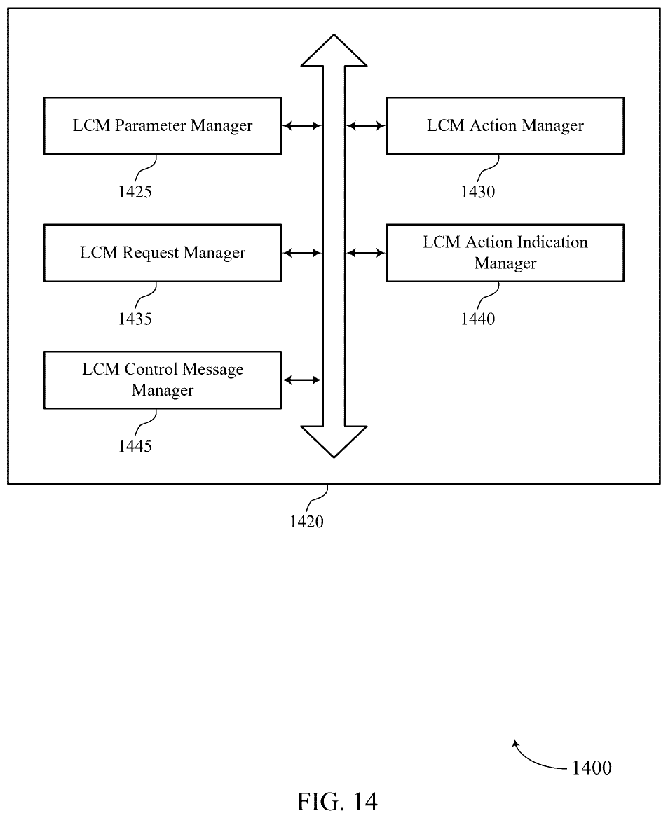

FIG. 14 shows a block diagram 1400 of a communications manager 1420 that supports AI-based LCM signaling in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of AI-based LCM signaling as described herein. For example, the communications manager 1420 may include an LCM parameter manager 1425, an LCM action manager 1430, an LCM request manager 1435, an LCM action indication manager 1440, an LCM control message manager 1445, or any combination thereof. Each of these components, or components or subcomponents thereof (e.g., one or more processors, one or more memories), may communicate, directly or indirectly, with one another (e.g., via one or more buses).

The communications manager 1420 may support wireless communications in accordance with examples as disclosed herein. The LCM parameter manager 1425 is capable of, configured to, or operable to support a means for receiving, from a first network entity, a control message including an indication of one or more monitoring parameters associated with LCM of one or more AI-based functionalities or models of the UE. The LCM action manager 1430 is capable of, configured to, or operable to support a means for performing, based on satisfaction of at least one monitoring parameter of the one or more monitoring parameters for a communication link associated with a second network entity, an LCM action associated with at least one AI-based functionality or model of the one or more AI-based functionalities or models.

In some examples, the LCM request manager 1435 is capable of, configured to, or operable to support a means for transmitting, to one of the first network entity or the second network entity, an LCM request message, where the LCM action is performed based on the LCM request message.

In some examples, the LCM control message manager 1445 is capable of, configured to, or operable to support a means for receiving, from the first network entity or the second network entity and based on the LCM request message, an LCM control message that indicates a configuration for the at least one AI-based functionality, where the LCM action is based on the configuration.

In some examples, the LCM request message includes a request for the configuration.

In some examples, the LCM request message includes an indication of the satisfaction of the at least one monitoring parameter.

In some examples, the LCM action indication manager 1440 is capable of, configured to, or operable to support a means for transmitting, to one of the first network entity or the second network entity, a second control message that indicates performance of the LCM action.

In some examples, to support performing the LCM action, the LCM action manager 1430 is capable of, configured to, or operable to support a means for activating the at least one AI-based functionality or model, deactivating the at least one AI-based functionality or model, switching the at least one AI-based functionality or model from a first configuration to another AI-based functionality or model, or switching the at least one AI-based functionality or model to a non-AI-based UE function.

In some examples, the one or more AI-based functionalities or models include layer 1 beam predictions, layer 3 beam measurements, radio link failure predictions, handover predictions, beam failure predictions, measurement event prediction, or a combination thereof.

In some examples, the one or more monitoring parameters include an accuracy of the layer 1 beam predictions, an accuracy of the layer 3 beam measurements, an accuracy of the radio link failure predictions, an accuracy of the handover predictions, an accuracy of the beam failure predictions, satisfaction of a counter, or a combination thereof.

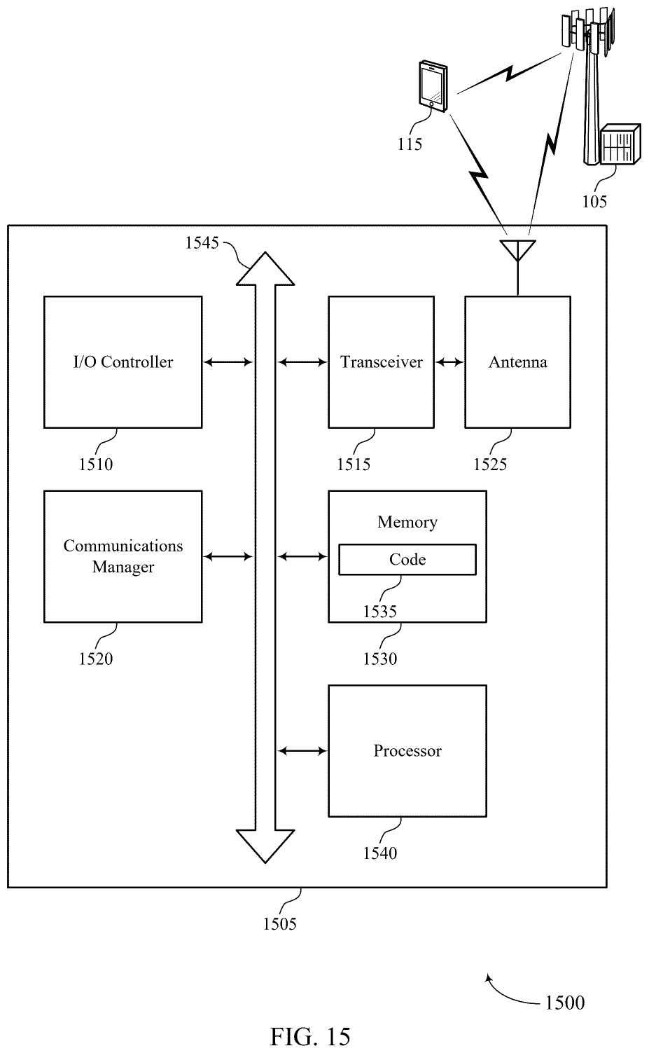

FIG. 15 shows a diagram of a system 1500 including a device 1505 that supports AI-based LCM signaling in accordance with one or more aspects of the present disclosure. The device 1505 may be an example of or include components of a device 1205, a device 1305, or a UE 115 as described herein. The device 1505 may communicate (e.g., wirelessly) with one or more other devices (e.g., network entities 105, UEs 115, or a combination thereof). The device 1505 may include components for bi-directional voice and data communications including components for transmitting and receiving communications, such as a communications manager 1520, an input/output (I/O) controller, such as an I/O controller 1510, a transceiver 1515, one or more antennas 1525, at least one memory 1530, code 1535, and at least one processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of one or more processors, such as the at least one processor 1540. In some cases, a user may interact with the device 1505 via the I/O controller 1510 or via hardware components controlled by the I/O controller 1510.

In some cases, the device 1505 may include a single antenna. However, in some other cases, the device 1505 may have more than one antenna, which may be capable of concurrently transmitting or receiving multiple wireless transmissions. The transceiver 1515 may communicate bi-directionally via the one or more antennas 1525 using wired or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The at least one memory 1530 may include random access memory (RAM) and read-only memory (ROM). The at least one memory 1530 may store computer-readable, computer-executable, or processor-executable code, such as the code 1535. The code 1535 may include instructions that, when executed by the at least one processor 1540, cause the device 1505 to perform various functions described herein. The code 1535 may be stored in a non-transitory computer-readable medium such as system memory or another type of memory. In some cases, the code 1535 may not be directly executable by the at least one processor 1540 but may cause a computer (e.g., when compiled and executed) to perform functions described herein. In some cases, the at least one memory 1530 may include, among other things, a basic I/O system (BIOS) which may control basic hardware or software operation such as the interaction with peripheral components or devices.

The at least one processor 1540 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1540 may be configured to operate a memory array using a memory controller. In some other cases, a memory controller may be integrated into the at least one processor 1540. The at least one processor 1540 may be configured to execute computer-readable instructions stored in a memory (e.g., the at least one memory 1530) to cause the device 1505 to perform various functions (e.g., functions or tasks supporting AI-based LCM signaling). For example, the device 1505 or a component of the device 1505 may include at least one processor 1540 and at least one memory 1530 coupled with or to the at least one processor 1540, the at least one processor 1540 and the at least one memory 1530 configured to perform various functions described herein.

In some examples, the at least one processor 1540 may include multiple processors and the at least one memory 1530 may include multiple memories. One or more of the multiple processors may be coupled with one or more of the multiple memories, which may, individually or collectively, be configured to perform various functions described herein. In some examples, the at least one processor 1540 may be a component of a processing system, which may refer to a system (such as a series) of machines, circuitry (including, for example, one or both of processor circuitry (which may include the at least one processor 1540) and memory circuitry (which may include the at least one memory 1530)), or components, that receives or obtains inputs and processes the inputs to produce, generate, or obtain a set of outputs. The processing system may be configured to perform one or more of the functions described herein. For example, the at least one processor 1540 or a processing system including the at least one processor 1540 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code 1535 (e.g., processor-executable code) stored in the at least one memory 1530 or otherwise, to perform one or more of the functions described herein.

The communications manager 1520 may support wireless communications in accordance with examples as disclosed herein. For example, the communications manager 1520 is capable of, configured to, or operable to support a means for receiving, from a first network entity, a control message including an indication of one or more monitoring parameters associated with LCM of one or more AI-based functionalities or models of the UE. The communications manager 1520 is capable of, configured to, or operable to support a means for performing, based on satisfaction of at least one monitoring parameter of the one or more monitoring parameters for a communication link associated with a second network entity, an LCM action associated with at least one AI-based functionality or model of the one or more AI-based functionalities or models.

By including or configuring the communications manager 1520 in accordance with examples as described herein, the device 1505 may support techniques for more efficient utilization of communication resources, improved coordination between devices, and improved utilization of processing capability.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the at least one processor 1540, the at least one memory 1530, the code 1535, or any combination thereof. For example, the code 1535 may include instructions executable by the at least one processor 1540 to cause the device 1505 to perform various aspects of AI-based LCM signaling as described herein, or the at least one processor 1540 and the at least one memory 1530 may be otherwise configured to, individually or collectively, perform or support such operations.

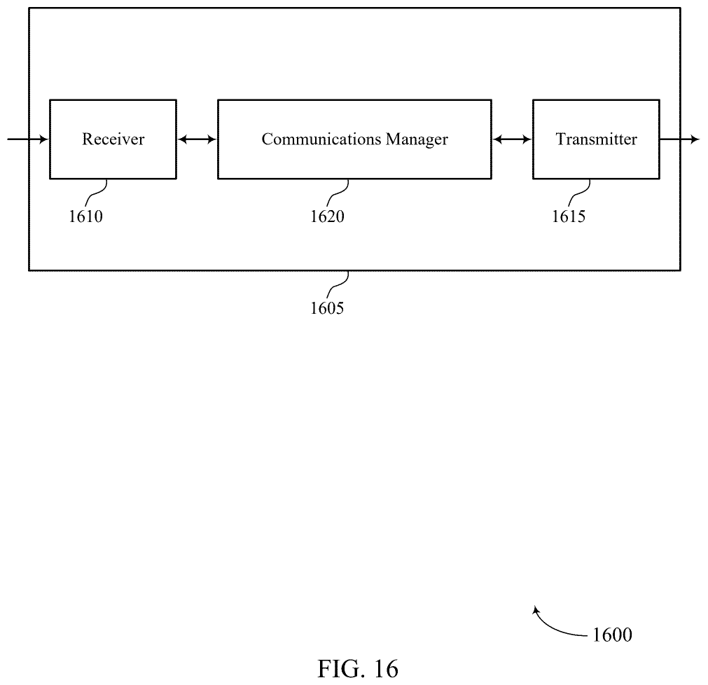

FIG. 16 shows a block diagram 1600 of a device 1605 that supports AI-based LCM signaling in accordance with one or more aspects of the present disclosure. The device 1605 may be an example of aspects of a network entity 105 as described herein. The device 1605 may include a receiver 1610, a transmitter 1615, and a communications manager 1620. The device 1605, or one or more components of the device 1605 (e.g., the receiver 1610, the transmitter 1615, the communications manager 1620), may include at least one processor, which may be coupled with at least one memory, to, individually or collectively, support or enable the described techniques. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The communications manager 1620, the receiver 1610, the transmitter 1615, or various combinations or components thereof may be examples of means for performing various aspects of AI-based LCM signaling as described herein. For example, the communications manager 1620, the receiver 1610, the transmitter 1615, or various combinations or components thereof may be capable of performing one or more of the functions described herein.

In some examples, the communications manager 1620, the receiver 1610, the transmitter 1615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1620, the receiver 1610, the transmitter 1615, or various combinations or components thereof may be implemented in code (e.g., as communications management software or firmware) executed by at least one processor (e.g., referred to as a processor-executable code). If implemented in code executed by at least one processor, the functions of the communications manager 1620, the receiver 1610, the transmitter 1615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1620 may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. For example, the communications manager 1620 is capable of, configured to, or operable to support a means for obtaining, from a UE, a capability message indicating one or more AI-based functionalities or models of the UE. The communications manager 1620 is capable of, configured to, or operable to support a means for obtaining, from a second network entity, a control message that indicates one or more performance parameters associated with the UE, the one or more performance parameters associated with at least one AI-based functionality or model of the one or more AI-based functionalities or models. The communications manager 1620 is capable of, configured to, or operable to support a means for outputting, to the UE based on the capability message and the control message, an LCM control message that indicates a configuration for the at least one AI-based functionality or model.

Additionally, or alternatively, the communications manager 1620 may support wireless communications in accordance with examples as disclosed herein. For example, the communications manager 1620 is capable of, configured to, or operable to support a means for obtaining, from a second network entity, a first control message that indicates one or more performance parameters associated with a UE, the one or more performance parameters associated with at least one AI-based functionality or model of one or more AI-based functionalities or models of the UE. The communications manager 1620 is capable of, configured to, or operable to support a means for outputting, to a third network entity in communication with the UE, a second control message based on the one or more performance parameters.

By including or configuring the communications manager 1620 in accordance with examples as described herein, the device 1605 (e.g., at least one processor controlling or otherwise coupled with the receiver 1610, the transmitter 1615, the communications manager 1620, or a combination thereof) may support techniques for more efficient utilization of communication resources.

The communications manager 1620 may be an example of means for performing various aspects of LCM for UE AI/ML functionalities in mobility cases as described herein. The communications manager 1620, or its sub-components, may be implemented in hardware (e.g., in communications management circuitry). The circuitry may comprise of processor, DSP, an ASIC, an FPGA or other programmable logic device, discrete gate or transistor logic, discrete hardware components, or any combination thereof designed to perform the functions described in the present disclosure.

In another implementation, the communications manager 1620, or its sub-components, may be implemented in code (e.g., as communications management software or firmware) executed by a processor, or any combination thereof. If implemented in code executed by a processor, the functions of the communications manager 1620, or its sub-components may be executed by a general-purpose processor, a DSP, an ASIC, an FPGA or other programmable logic device.

In some examples, the communications manager 1620 may be configured to perform various operations (e.g., receiving, determining, transmitting) using or otherwise in cooperation with the receiver 1610, the transmitter 1615, or both.

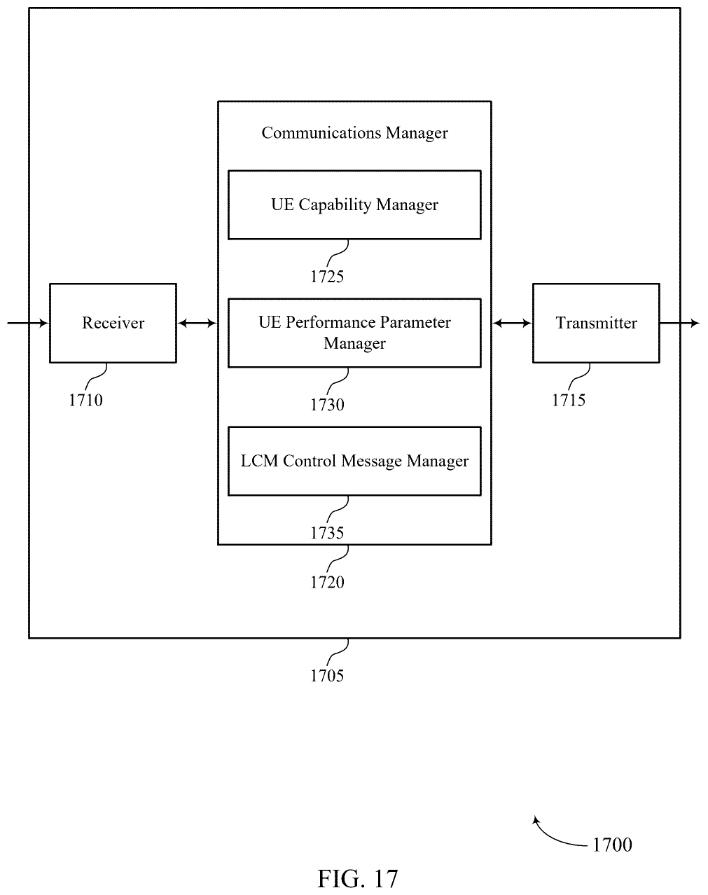

FIG. 17 shows a block diagram 1700 of a device 1705 that supports AI-based LCM signaling in accordance with one or more aspects of the present disclosure. The device 1705 may be an example of aspects of a device 1605 or a network entity 105 as described herein. The device 1705 may include a receiver 1710, a transmitter 1715, and a communications manager 1720. The device 1705, or one or more components of the device 1705 (e.g., the receiver 1710, the transmitter 1715, the communications manager 1720), may include at least one processor, which may be coupled with at least one memory, to support the described techniques. Each of these components may be in communication with one another (e.g., via one or more buses).

The receiver 1710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1705. In some examples, the receiver 1710 may support obtaining information by receiving signals via one or more antennas. Additionally, or alternatively, the receiver 1710 may support obtaining information by receiving signals via one or more wired (e.g., electrical, fiber optic) interfaces, wireless interfaces, or any combination thereof.

The transmitter 1715 may provide a means for outputting (e.g., transmitting, providing, conveying, sending) information generated by other components of the device 1705. For example, the transmitter 1715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1715 may support outputting information by transmitting signals via one or more antennas. Additionally, or alternatively, the transmitter 1715 may support outputting information by transmitting signals via one or more wired (e.g., electrical, fiber optic) interfaces, wireless interfaces, or any combination thereof. In some examples, the transmitter 1715 and the receiver 1710 may be co-located in a transceiver, which may include or be coupled with a modem.

The device 1705, or various components thereof, may be an example of means for performing various aspects of AI-based LCM signaling as described herein. For example, the communications manager 1720 may include a UE capability manager 1725, a UE performance parameter manager 1730, an LCM control message manager 1735, or any combination thereof. The communications manager 1720 may be an example of aspects of a communications manager 1620 as described herein. In some examples, the communications manager 1720, or various components thereof, may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The communications manager 1720 may support wireless communications in accordance with examples as disclosed herein. The UE capability manager 1725 is capable of, configured to, or operable to support a means for obtaining, from a UE, a capability message indicating one or more AI-based functionalities or models of the UE. The UE performance parameter manager 1730 is capable of, configured to, or operable to support a means for obtaining, from a second network entity, a control message that indicates one or more performance parameters associated with the UE, the one or more performance parameters associated with at least one AI-based functionality or model of the one or more AI-based functionalities or models. The LCM control message manager 1735 is capable of, configured to, or operable to support a means for outputting, to the UE based on the capability message and the control message, an LCM control message that indicates a configuration for the at least one AI-based functionality or model.

Additionally, or alternatively, the communications manager 1720 may support wireless communications in accordance with examples as disclosed herein. The UE performance parameter manager 1730 is capable of, configured to, or operable to support a means for obtaining, from a second network entity, a first control message that indicates one or more performance parameters associated with a UE, the one or more performance parameters associated with at least one AI-based functionality or model of one or more AI-based functionalities or models of the UE. The UE performance parameter manager 1730 is capable of, configured to, or operable to support a means for outputting, to a third network entity in communication with the UE, a second control message based on the one or more performance parameters.

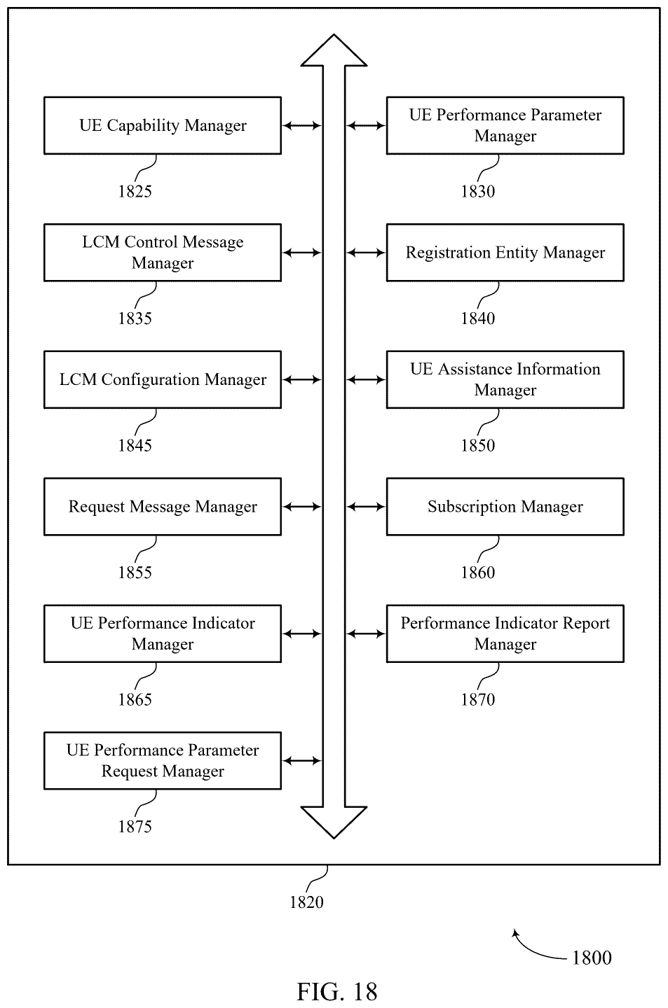

FIG. 18 shows a block diagram 1800 of a communications manager 1820 that supports AI-based LCM signaling in accordance with one or more aspects of the present disclosure. The communications manager 1820 may be an example of aspects of a communications manager 1620, a communications manager 1720, or both, as described herein. The communications manager 1820, or various components thereof, may be an example of means for performing various aspects of AI-based LCM signaling as described herein. For example, the communications manager 1820 may include a UE capability manager 1825, a UE performance parameter manager 1830, an LCM control message manager 1835, a registration entity manager 1840, an LCM configuration manager 1845, a UE assistance information manager 1850, a request message manager 1855, a subscription manager 1860, a UE performance indicator manager 1865, a performance indicator report manager 1870, a UE performance parameter request manager 1875, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1820 may support wireless communications in accordance with examples as disclosed herein. The UE capability manager 1825 is capable of, configured to, or operable to support a means for obtaining, from a UE, a capability message indicating one or more AI-based functionalities or models of the UE. The UE performance parameter manager 1830 is capable of, configured to, or operable to support a means for obtaining, from a second network entity, a control message that indicates one or more performance parameters associated with the UE, the one or more performance parameters associated with at least one AI-based functionality or model of the one or more AI-based functionalities or models. The LCM control message manager 1835 is capable of, configured to, or operable to support a means for outputting, to the UE based on the capability message and the control message, an LCM control message that indicates a configuration for the at least one AI-based functionality or model.

In some examples, to support obtaining the control message from the second network entity, the registration entity manager 1840 is capable of, configured to, or operable to support a means for obtaining, from a registration entity, a message including an indication of a logical or physical model associated with a UE type of the UE, the logical or physical model associated with the one or more performance parameters, where the registration entity includes the second network entity.

In some examples, the registration entity manager 1840 is capable of, configured to, or operable to support a means for obtaining, from the registration entity, advertisement information that indicates a set of UE types or a set of respective logical models, the set of UE types including the UE type, or the set of respective logical models including the logical or physical model.

In some examples, the UE performance indicator manager 1865 is capable of, configured to, or operable to support a means for obtaining, from a third network entity, one or more additional performance indicators associated with the one or more performance parameters, where transmission of the LCM control message is based on an application of the one or more additional performance indicators to the logical or physical model.

In some examples, to support obtaining the control message from the second network entity, the LCM configuration manager 1845 is capable of, configured to, or operable to support a means for obtaining, from an access and mobility entity, the control message that indicates the configuration for the at least one AI-based functionality or model, where the one or more performance parameters are associated with the configuration.

In some examples, the control message that indicates the configuration is based on one or more additional performance indicators for the UE associated with the at least one AI-based functionality or model stored at an operations and management entity.

In some examples, to support obtaining the control message from the second network entity, the LCM configuration manager 1845 is capable of, configured to, or operable to support a means for obtaining, from an operations and management entity, the control message that indicates the configuration for the at least one AI-based functionality or model, where the configuration includes the one or more performance parameters.

In some examples, the control message that indicates the configuration is based on one or more additional performance indicators for the UE associated with the at least one AI-based functionality or model stored at the operations and management entity.

In some examples, the UE assistance information manager 1850 is capable of, configured to, or operable to support a means for obtaining assistance information that indicates an identifier for the UE. In some examples, the request message manager 1855 is capable of, configured to, or operable to support a means for outputting, to the second network entity, a request message for one or more additional performance indicators for the UE, where the request message includes the identifier for the UE, and where obtaining the control message includes obtaining the one or more additional performance indicators for the UE associated with the one or more performance parameters based on inclusion of the identifier in the request message. In some examples, the identifier includes an encrypted identifier.

In some examples, the performance indicator report manager 1870 is capable of, configured to, or operable to support a means for outputting, to the second network entity, a report indicating one or more second performance indicators associated with the configuration for the at least one AI-based functionality or model based on communication between the UE and the first network entity.

In some examples, the configuration includes activating the at least one AI-based functionality or model, deactivating the at least one AI-based functionality or model, switching the at least one AI-based functionality or model from a second configuration to another AI-based functionality or model, or switching the at least one AI-based functionality or model to a non-AI-based UE function.

In some examples, the one or more AI-based functionalities or models include layer 1 beam predictions, layer 3 beam measurements, radio link failure predictions, handover predictions, beam failure predictions, or a combination thereof.

In some examples, the one or more performance parameters includes an accuracy of the layer 1 beam predictions, an accuracy of the layer 3 beam measurements, an accuracy of the radio link failure predictions, an accuracy of the handover predictions, an accuracy of the beam failure predictions, satisfaction of a counter, or a combination thereof.

Additionally, or alternatively, the communications manager 1820 may support wireless communications in accordance with examples as disclosed herein. In some examples, the UE performance parameter manager 1830 is capable of, configured to, or operable to support a means for obtaining, from a second network entity, a first control message that indicates one or more performance parameters associated with a UE, the one or more performance parameters associated with at least one AI-based functionality or model of one or more AI-based functionalities or models of the UE. In some examples, the UE performance parameter manager 1830 is capable of, configured to, or operable to support a means for outputting, to a third network entity in communication with the UE, a second control message based on the one or more performance parameters.

In some examples, to support outputting the second control message, the LCM control message manager 1835 is capable of, configured to, or operable to support a means for outputting an LCM control message that indicates a configuration for the at least one AI-based functionality or model.

In some examples, the configuration is based on or more additional performance indicators for the UE associated with the at least one AI-based functionality or model stored at an operations and management entity.

In some examples, to support obtaining the first control message from the second network entity, the LCM configuration manager 1845 is capable of, configured to, or operable to support a means for obtaining, from an operations and management entity, the first control message that indicates the configuration for the at least one AI-based functionality or model, where the configuration includes the one or more performance parameters.

In some examples, the configuration includes activating the at least one AI-based functionality or model, deactivating the at least one AI-based functionality or model, switching the at least one AI-based functionality or model from a second configuration to another AI-based functionality or model, or switching the at least one AI-based functionality or model to non-AI-based UE function.

In some examples, the one or more AI-based functionalities or models include layer 1 beam predictions, layer 3 beam measurements, radio link failure predictions, handover predictions, beam failure predictions, measurement event prediction or a combination thereof.

In some examples, the subscription manager 1860 is capable of, configured to, or operable to support a means for communicating, with the second network entity and prior to obtaining the first control message, a third control message that indicates a subscription for a model identifier associated with the UE, the model identifier associated with the one or more performance parameters. In some examples, the UE performance indicator manager 1865 is capable of, configured to, or operable to support a means for receiving, from the third network entity, a first report message indicating one or more additional performance indicators for the UE associated with the at least one AI-based functionality or model. In some examples, the UE performance parameter manager 1830 is capable of, configured to, or operable to support a means for outputting, to the second network entity, a second report message indicating the one or more additional performance indicators, where obtaining the first control message is based on the second report message.

In some examples, the UE performance parameter request manager 1875 is capable of, configured to, or operable to support a means for obtaining, from the third network entity, a first request message for the one or more performance parameters. In some examples, the UE performance parameter request manager 1875 is capable of, configured to, or operable to support a means for outputting, to the second network entity and based on the first request message, a second request message for the one or more performance parameters, where obtaining the first control message is based on the second request message.

In some examples, the one or more performance parameters includes an accuracy of layer 1 beam predictions, an accuracy of layer 3 beam measurements, an accuracy of radio link failure predictions, an accuracy of handover predictions, an accuracy of beam failure predictions, satisfaction of a counter, accuracy of measurement event prediction, or a combination thereof.

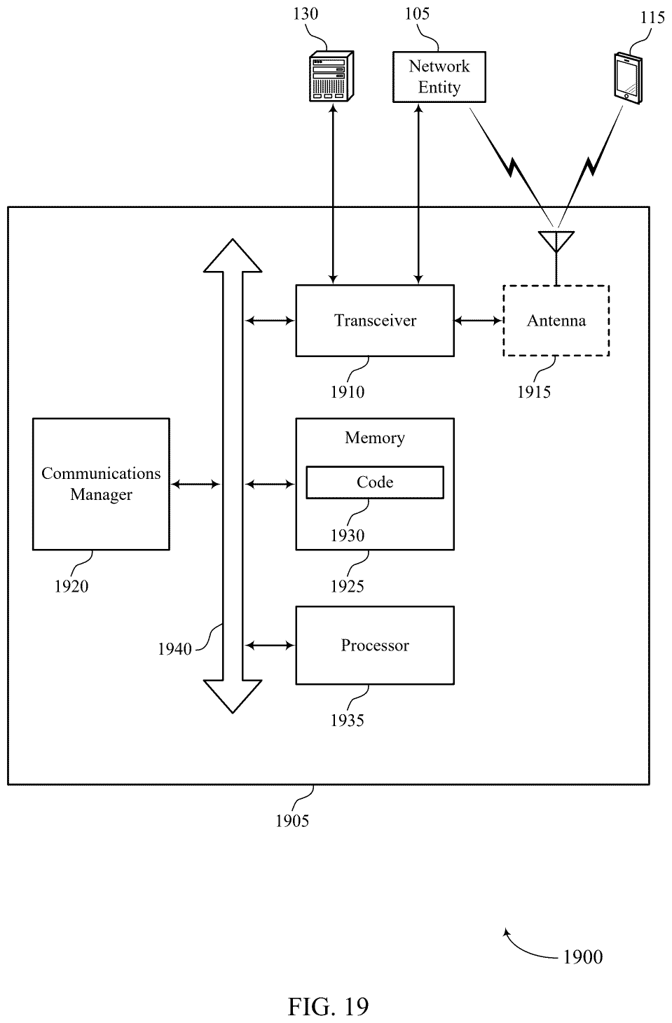

FIG. 19 shows a diagram of a system 1900 including a device 1905 that supports AI-based LCM signaling in accordance with one or more aspects of the present disclosure. The device 1905 may be an example of or include components of a device 1605, a device 1705, or a network entity 105 as described herein. The device 1905 may communicate with other network devices or network equipment such as one or more of the network entities 105, UEs 115, or any combination thereof. The communications may include communications over one or more wired interfaces, over one or more wireless interfaces, or any combination thereof. The device 1905 may include components that support outputting and obtaining communications, such as a communications manager 1920, a transceiver 1910, one or more antennas 1915, at least one memory 1925, code 1930, and at least one processor 1935. These components may be in electronic communication or otherwise coupled (e.g., operatively, communicatively, functionally, electronically, electrically) via one or more buses (e.g., a bus 1940).

The transceiver 1910 may support bi-directional communications via wired links, wireless links, or both as described herein. In some examples, the transceiver 1910 may include a wired transceiver and may communicate bi-directionally with another wired transceiver. Additionally, or alternatively, in some examples, the transceiver 1910 may include a wireless transceiver and may communicate bi-directionally with another wireless transceiver. In some examples, the device 1905 may include one or more antennas 1915, which may be capable of transmitting or receiving wireless transmissions (e.g., concurrently). The transceiver 1910 may also include a modem to modulate signals, to provide the modulated signals for transmission (e.g., by one or more antennas 1915, by a wired transmitter), to receive modulated signals (e.g., from one or more antennas 1915, from a wired receiver), and to demodulate signals. In some implementations, the transceiver 1910 may include one or more interfaces, such as one or more interfaces coupled with the one or more antennas 1915 that are configured to support various receiving or obtaining operations, or one or more interfaces coupled with the one or more antennas 1915 that are configured to support various transmitting or outputting operations, or a combination thereof. In some implementations, the transceiver 1910 may include or be configured for coupling with one or more processors or one or more memory components that are operable to perform or support operations based on received or obtained information or signals, or to generate information or other signals for transmission or other outputting, or any combination thereof. In some implementations, the transceiver 1910, or the transceiver 1910 and the one or more antennas 1915, or the transceiver 1910 and the one or more antennas 1915 and one or more processors or one or more memory components (e.g., the at least one processor 1935, the at least one memory 1925, or both), may be included in a chip or chip assembly that is installed in the device 1905. In some examples, the transceiver 1910 may be operable to support communications via one or more communications links (e.g., communication link(s) 125, backhaul communication link(s) 120, a midhaul communication link 162, a fronthaul communication link 168).

The at least one memory 1925 may include RAM, ROM, or any combination thereof. The at least one memory 1925 may store computer-readable, computer-executable, or processor-executable code, such as the code 1930. The code 1930 may include instructions that, when executed by one or more of the at least one processor 1935, cause the device 1905 to perform various functions described herein. The code 1930 may be stored in a non-transitory computer-readable medium such as system memory or another type of memory. In some cases, the code 1930 may not be directly executable by a processor of the at least one processor 1935 but may cause a computer (e.g., when compiled and executed) to perform functions described herein. In some cases, the at least one memory 1925 may include, among other things, a BIOS which may control basic hardware or software operation such as the interaction with peripheral components or devices. In some examples, the at least one processor 1935 may include multiple processors and the at least one memory 1925 may include multiple memories. One or more of the multiple processors may be coupled with one or more of the multiple memories which may, individually or collectively, be configured to perform various functions herein (for example, as part of a processing system).

The at least one processor 1935 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1935 may be configured to operate a memory array using a memory controller. In some other cases, a memory controller may be integrated into one or more of the at least one processor 1935. The at least one processor 1935 may be configured to execute computer-readable instructions stored in a memory (e.g., one or more of the at least one memory 1925) to cause the device 1905 to perform various functions (e.g., functions or tasks supporting AI-based LCM signaling). For example, the device 1905 or a component of the device 1905 may include at least one processor 1935 and at least one memory 1925 coupled with one or more of the at least one processor 1935, the at least one processor 1935 and the at least one memory 1925 configured to perform various functions described herein. The at least one processor 1935 may be an example of a cloud-computing platform (e.g., one or more physical nodes and supporting software such as operating systems, virtual machines, or container instances) that may host the functions (e.g., by executing code 1930) to perform the functions of the device 1905. The at least one processor 1935 may be any one or more suitable processors capable of executing scripts or instructions of one or more software programs stored in the device 1905 (such as within one or more of the at least one memory 1925).

In some examples, the at least one processor 1935 may include multiple processors and the at least one memory 1925 may include multiple memories. One or more of the multiple processors may be coupled with one or more of the multiple memories, which may, individually or collectively, be configured to perform various functions herein. In some examples, the at least one processor 1935 may be a component of a processing system, which may refer to a system (such as a series) of machines, circuitry (including, for example, one or both of processor circuitry (which may include the at least one processor 1935) and memory circuitry (which may include the at least one memory 1925)), or components, that receives or obtains inputs and processes the inputs to produce, generate, or obtain a set of outputs. The processing system may be configured to perform one or more of the functions described herein. For example, the at least one processor 1935 or a processing system including the at least one processor 1935 may be configured to, configurable to, or operable to cause the device 1905 to perform one or more of the functions described herein. Further, as described herein, being “configured to,” being “configurable to,” and being “operable to” may be used interchangeably and may be associated with a capability, when executing code stored in the at least one memory 1925 or otherwise, to perform one or more of the functions described herein.

In some examples, a bus 1940 may support communications of (e.g., within) a protocol layer of a protocol stack. In some examples, a bus 1940 may support communications associated with a logical channel of a protocol stack (e.g., between protocol layers of a protocol stack), which may include communications performed within a component of the device 1905, or between different components of the device 1905 that may be co-located or located in different locations (e.g., where the device 1905 may refer to a system in which one or more of the communications manager 1920, the transceiver 1910, the at least one memory 1925, the code 1930, and the at least one processor 1935 may be located in one of the different components or divided between different components).

In some examples, the communications manager 1920 may manage aspects of communications with a core network 130 (e.g., via one or more wired or wireless backhaul links). For example, the communications manager 1920 may manage the transfer of data communications for client devices, such as one or more UEs 115. In some examples, the communications manager 1920 may manage communications with one or more other network entities 105, and may include a controller or scheduler for controlling communications with UEs 115 (e.g., in cooperation with the one or more other network devices). In some examples, the communications manager 1920 may support an X2 interface within an LTE/LTE-A wireless communications network technology to provide communication between network entities 105.

The communications manager 1920 may support wireless communications in accordance with examples as disclosed herein. For example, the communications manager 1920 is capable of, configured to, or operable to support a means for obtaining, from a UE, a capability message indicating one or more AI-based functionalities or models of the UE. The communications manager 1920 is capable of, configured to, or operable to support a means for obtaining, from a second network entity, a control message that indicates one or more performance parameters associated with the UE, the one or more performance parameters associated with at least one AI-based functionality or model of the one or more AI-based functionalities or models. The communications manager 1920 is capable of, configured to, or operable to support a means for outputting, to the UE based on the capability message and the control message, an LCM control message that indicates a configuration for the at least one AI-based functionality or model.

Additionally, or alternatively, the communications manager 1920 may support wireless communications in accordance with examples as disclosed herein. For example, the communications manager 1920 is capable of, configured to, or operable to support a means for obtaining, from a second network entity, a first control message that indicates one or more performance parameters associated with a UE, the one or more performance parameters associated with at least one AI-based functionality or model of one or more AI-based functionalities or models of the UE. The communications manager 1920 is capable of, configured to, or operable to support a means for outputting, to a third network entity in communication with the UE, a second control message based on the one or more performance parameters.

By including or configuring the communications manager 1920 in accordance with examples as described herein, the device 1905 may support techniques for more efficient utilization of communication resources, improved coordination between devices, and improved utilization of processing capability.

In some examples, the communications manager 1920 may be configured to perform various operations (e.g., receiving, obtaining, monitoring, outputting, transmitting) using or otherwise in cooperation with the transceiver 1910, the one or more antennas 1915 (e.g., where applicable), or any combination thereof. Although the communications manager 1920 is illustrated as a separate component, in some examples, one or more functions described with reference to the communications manager 1920 may be supported by or performed by the transceiver 1910, one or more of the at least one processor 1935, one or more of the at least one memory 1925, the code 1930, or any combination thereof (for example, by a processing system including at least a portion of the at least one processor 1935, the at least one memory 1925, the code 1930, or any combination thereof). For example, the code 1930 may include instructions executable by one or more of the at least one processor 1935 to cause the device 1905 to perform various aspects of AI-based LCM signaling as described herein, or the at least one processor 1935 and the at least one memory 1925 may be otherwise configured to, individually or collectively, perform or support such operations.

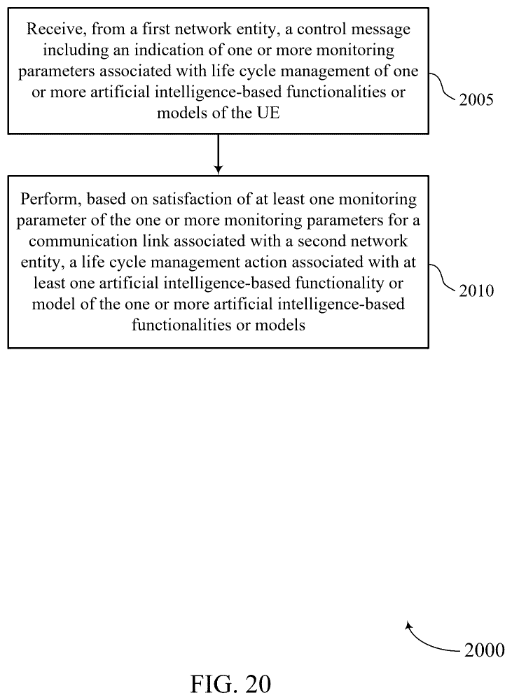

FIG. 20 shows a flowchart illustrating a method 2000 that supports AI-based LCM signaling in accordance with one or more aspects of the present disclosure. The operations of the method 2000 may be implemented by a UE or its components as described herein. For example, the operations of the method 2000 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2005, the method may include receiving, from a first network entity, a control message including an indication of one or more monitoring parameters associated with LCM of one or more AI-based functionalities or models of the UE. The operations of 2005 may be performed in accordance with examples as disclosed herein. In some examples, aspects of the operations of 2005 may be performed by an LCM parameter manager 1425 as described with reference to FIG. 14.

At 2010, the method may include performing, based on satisfaction of at least one monitoring parameter of the one or more monitoring parameters for a communication link associated with a second network entity, an LCM action associated with at least one AI-based functionality or model of the one or more AI-based functionalities or models. The operations of 2010 may be performed in accordance with examples as disclosed herein. In some examples, aspects of the operations of 2010 may be performed by an LCM action manager 1430 as described with reference to FIG. 14.

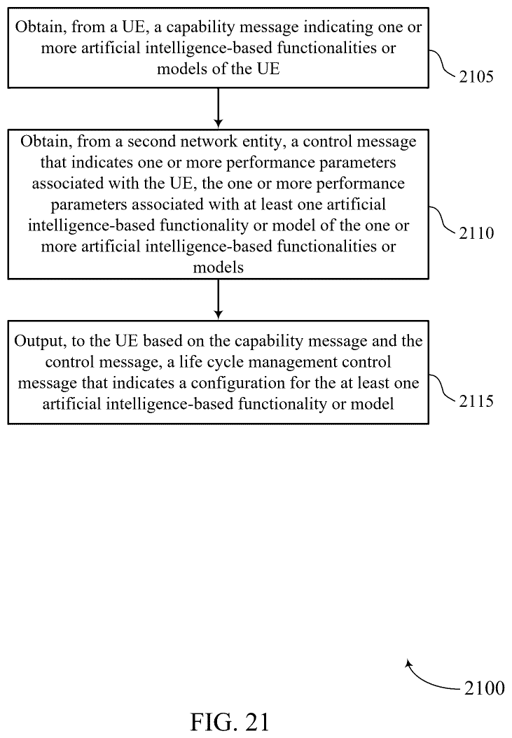

FIG. 21 shows a flowchart illustrating a method 2100 that supports AI-based LCM signaling in accordance with one or more aspects of the present disclosure. The operations of the method 2100 may be implemented by a network entity or its components as described herein. For example, the operations of the method 2100 may be performed by a network entity as described with reference to FIGS. 1 through 11 and 16 through 19. In some examples, a network entity may execute a set of instructions to control the functional elements of the network entity to perform the described functions. Additionally, or alternatively, the network entity may perform aspects of the described functions using special-purpose hardware.

At 2105, the method may include obtaining, from a UE, a capability message indicating one or more AI-based functionalities or models of the UE. The operations of 2105 may be performed in accordance with examples as disclosed herein. In some examples, aspects of the operations of 2105 may be performed by a UE capability manager 1825 as described with reference to FIG. 18.

At 2110, the method may include obtaining, from a second network entity, a control message that indicates one or more performance parameters associated with the UE, the one or more performance parameters associated with at least one AI-based functionality or model of the one or more AI-based functionalities or models. The operations of 2110 may be performed in accordance with examples as disclosed herein. In some examples, aspects of the operations of 2110 may be performed by a UE performance parameter manager 1830 as described with reference to FIG. 18.

At 2115, the method may include outputting, to the UE based on the capability message and the control message, an LCM control message that indicates a configuration for the at least one AI-based functionality or model. The operations of 2115 may be performed in accordance with examples as disclosed herein. In some examples, aspects of the operations of 2115 may be performed by an LCM control message manager 1835 as described with reference to FIG. 18.

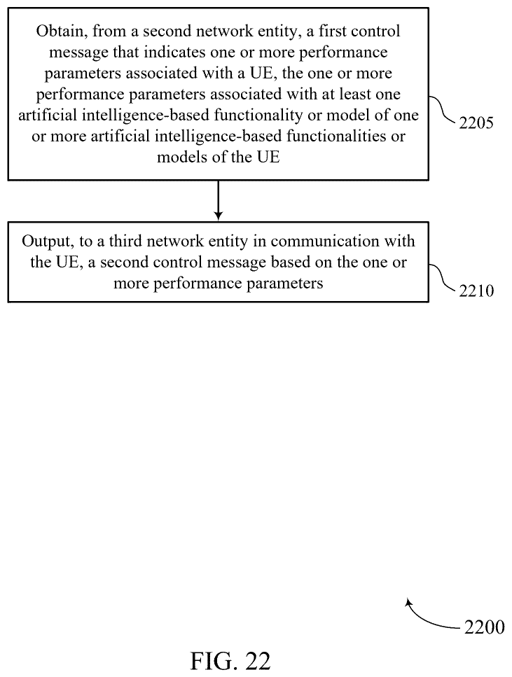

FIG. 22 shows a flowchart illustrating a method 2200 that supports AI-based LCM signaling in accordance with one or more aspects of the present disclosure. The operations of the method 2200 may be implemented by a network entity or its components as described herein. For example, the operations of the method 2200 may be performed by a network entity as described with reference to FIGS. 1 through 11 and 16 through 19. In some examples, a network entity may execute a set of instructions to control the functional elements of the network entity to perform the described functions. Additionally, or alternatively, the network entity may perform aspects of the described functions using special-purpose hardware.

At 2205, the method may include obtaining, from a second network entity, a first control message that indicates one or more performance parameters associated with a UE, the one or more performance parameters associated with at least one AI-based functionality or model of one or more AI-based functionalities or models of the UE. The operations of 2205 may be performed in accordance with examples as disclosed herein. In some examples, aspects of the operations of 2205 may be performed by a UE performance parameter manager 1830 as described with reference to FIG. 18.

At 2210, the method may include outputting, to a third network entity in communication with the UE, a second control message based on the one or more performance parameters. The operations of 2210 may be performed in accordance with examples as disclosed herein. In some examples, aspects of the operations of 2210 may be performed by a UE performance parameter manager 1830 as described with reference to FIG. 18.

The following provides an overview of aspects of the present disclosure:

Aspect 1: A method for wireless communications at a UE, comprising: receiving, from a first network entity, a control message comprising an indication of one or more monitoring parameters associated with LCM of one or more AI-based functionalities or models of the UE; and performing, based at least in part on satisfaction of at least one monitoring parameter of the one or more monitoring parameters for a communication link associated with a second network entity, an LCM action associated with at least one AI-based functionality or model of the one or more AI-based functionalities or models.

Aspect 2: The method of aspect 1, further comprising: transmitting, to one of the first network entity or the second network entity, an LCM request message, wherein the LCM action is performed based at least in part on the LCM request message.

Aspect 3: The method of aspect 2, further comprising: receiving, from the first network entity or the second network entity and based at least in part on the LCM request message, an LCM control message that indicates a configuration for the at least one AI-based functionality or model, wherein the LCM action is based at least in part on the configuration.

Aspect 4: The method of aspect 3, wherein the LCM request message comprises a request for the configuration.

Aspect 5: The method of any of aspects 2 through 4, wherein the LCM request message comprises an indication of the satisfaction of the at least one monitoring parameter.

Aspect 6: The method of any of aspects 1 through 5, further comprising: transmitting, to one of the first network entity or the second network entity, a second control message that indicates performance of the LCM action.

Aspect 7: The method of any of aspects 1 through 6, wherein the performing the LCM action comprises: activating the at least one AI-based functionality or model, deactivating the at least one AI-based functionality or model, switching the at least one AI-based functionality or model from a first configuration to another AI-based functionality or model, or switching the at least one AI-based functionality or model to a non-AI-based UE function.

Aspect 8: The method of any of aspects 1 through 7, wherein the one or more AI-based functionalities or models include layer 1 beam predictions, layer 3 beam measurements, radio link failure predictions, handover predictions, beam failure predictions, measurement event prediction, or a combination thereof.

Aspect 9: The method of aspect 8, wherein the one or more monitoring parameters comprise an accuracy of the layer 1 beam predictions, an accuracy of the layer 3 beam measurements, an accuracy of the radio link failure predictions, an accuracy of the handover predictions, an accuracy of the beam failure predictions, satisfaction of a counter, or a combination thereof.

Aspect 10: A method for wireless communications at a first network entity, comprising: obtaining a capability message that indicates one or more AI-based functionalities or models of a UE; obtaining, from a second network entity, a control message that indicates one or more performance parameters associated with the UE, the one or more performance parameters associated with at least one AI-based functionality or model of the one or more AI-based functionalities or models; and outputting, based at least in part on the capability message and the control message, an LCM control message that indicates a configuration for the at least one AI-based functionality or model.

Aspect 11: The method of aspect 10, wherein obtaining the control message from the second network entity comprises: obtaining, from a registration entity, a message comprising an indication of a logical or physical model associated with a UE type of the UE, the logical or physical model associated with the one or more performance parameters, wherein the registration entity comprises the second network entity.

Aspect 12: The method of aspect 11, further comprising: obtaining, from the registration entity, advertisement information that indicates a set of UE types or a set of respective logical models, wherein the set of UE types includes the UE type, or the set of respective logical models includesthe logical or physical model.

Aspect 13: The method of any of aspects 11 through 12, further comprising: obtaining, from a third network entity, one or more additional performance indicators associated with the one or more performance parameters, wherein transmission of the LCM control message is based at least in part on an application of the one or more additional performance indicators to the logical or physical model.

Aspect 14: The method of aspect 10, wherein the obtaining the control message from the second network entity comprises: obtaining, from an access and mobility entity, the control message that indicates the configuration for the at least one AI-based functionality or model, wherein the one or more performance parameters are associated with the configuration.

Aspect 15: The method of aspect 14, wherein the control message that indicates the configuration is based at least in part on one or more additional performance indicators for the UE associated with the at least one AI-based functionality or model stored at an OAM entity.

Aspect 16: The method of aspect 10, wherein the obtaining the control message from the second network entity comprises: obtaining, from an OAM entity, the control message that indicates the configuration for the at least one AI-based functionality or model, wherein the configuration includes the one or more performance parameters.

Aspect 17: The method of aspect 16, wherein the control message that indicates the configuration is based at least in part on one or more additional performance indicators for the UE associated with the at least one AI-based functionality or model stored at the OAM entity.

Aspect 18: The method of any of aspects 10 through 17, further comprising: obtaining assistance information that indicates an identifier for the UE; and outputting, to the second network entity, a request message for one or more additional performance indicators for the UE, wherein the request message includes the identifier for the UE, and wherein obtaining the control message comprises obtaining the one or more additional performance indicators for the UE associated with the one or more performance parameters based at least in part on inclusion of the identifier in the request message.

Aspect 19: The method of aspect 18, wherein the identifier comprises an encrypted identifier.

Aspect 20: The method of any of aspects 18 through 19, further comprising: outputting, to the second network entity, a report indicating one or more second performance indicators associated with the configuration for the at least one AI-based functionality or model based at least in part on communication between the UE and the first network entity.

Aspect 21: The method of any of aspects 10 through 20, wherein the configuration comprises activating the at least one AI-based functionality or model, deactivating the at least one AI-based functionality or model, switching the at least one AI-based functionality or model from a second configuration to another AI-based functionality or model, or switching the at least one AI-based functionality or model to a non-AI-based UE function.

Aspect 22: The method of aspect 21, wherein the one or more AI-based functionalities or models include layer 1 beam predictions, layer 3 beam measurements, radio link failure predictions, handover predictions, beam failure predictions, or a combination thereof.

Aspect 23: The method of aspect 22, wherein the one or more performance parameters comprises an accuracy of the layer 1 beam predictions, an accuracy of the layer 3 beam measurements, an accuracy of the radio link failure predictions, an accuracy of the handover predictions, an accuracy of the beam failure predictions, satisfaction of a counter, or a combination thereof.

Aspect 24: A method for wireless communications at a first network entity, comprising: obtaining, from a second network entity, a first control message that indicates one or more performance parameters associated with a UE, the one or more performance parameters associated with at least one AI-based functionality or model of one or more AI-based functionalities or models of the UE; and outputting, to a third network entity in communication with the UE, a second control message based at least in part on the one or more performance parameters.

Aspect 25: The method of aspect 24, wherein outputting the second control message comprises: outputting an LCM control message that indicates a configuration for the at least one AI-based functionality or model.

Aspect 26: The method of aspect 25, wherein the configuration is based at least in part on one or more additional performance indicators for the UE associated with the at least one AI-based functionality or model stored at an OAM entity.

Aspect 27: The method of any of aspects 25 through 26, wherein the obtaining the first control message from the second network entity comprises: obtaining, from an OAM entity, the first control message that indicates the configuration for the at least one AI-based functionality or model, wherein the configuration includes the one or more performance parameters.

Aspect 28: The method of aspect 27, wherein the configuration comprises activating the at least one AI-based functionality or model, deactivating the at least one AI-based functionality or model, switching the at least one AI-based functionality or model from a second configuration to another AI-based functionality or model, or switching the at least one AI-based functionality or model to non-AI-based UE function.

Aspect 29: The method of aspect 28, wherein the one or more AI-based functionalities or models include layer 1 beam predictions, layer 3 beam measurements, radio link failure predictions, handover predictions, beam failure predictions, measurement event prediction or a combination thereof.

Aspect 30: The method of any of aspects 24 through 29, further comprising: communicating, with the second network entity and prior to obtaining the first control message, a third control message that indicates a subscription for a model identifier associated with the UE, the model identifier associated with the one or more performance parameters; receiving, from the third network entity, a first report message indicating one or more additional performance indicators for the UE associated with the at least one AI-based functionality or model; and outputting, to the second network entity, a second report message indicating the one or more additional performance indicators, wherein obtaining the first control message is based at least in part on the second report message.

Aspect 31: The method of aspect 30, further comprising: obtaining, from the third network entity, a first request message for the one or more performance parameters; and outputting, to the second network entity and based at least in part on the first request message, a second request message for the one or more performance parameters, wherein obtaining the first control message is based at least in part on the second request message.

Aspect 32: The method of any of aspects 24 through 31, wherein the one or more performance parameters comprises an accuracy of layer 1 beam predictions, an accuracy of layer 3 beam measurements, an accuracy of radio link failure predictions, an accuracy of handover predictions, an accuracy of beam failure predictions, satisfaction of a counter, accuracy of measurement event prediction, or a combination thereof.

Aspect 33: An apparatus for wireless communications at a UE, comprising one or more memories, and one or more processors coupled with the one or more memories and configured to cause the UE to perform a method of any of aspects 1 through 9.

Aspect 34: A UE for wireless communications, comprising at least one means for performing a method of any of aspects 1 through 9.

Aspect 35: A non-transitory computer-readable medium storing code for wireless communications at a UE, the code comprising instructions executable by one or more processors to cause the UE to perform a method of any of aspects 1 through 9.

Aspect 36: An apparatus for wireless communications at a first network entity, comprising one or more memories storing processor-executable code, and one or more processors coupled with the one or more memories and individually or collectively operable to execute the code to cause the first network entity to perform a method of any of aspects 10 through 23.

Aspect 37: A first network entity for wireless communications, comprising at least one means for performing a method of any of aspects 10 through 23.

Aspect 38: A non-transitory computer-readable medium storing code for wireless communications at a first network entity, the code comprising instructions executable by one or more processors to cause the first network entity to perform a method of any of aspects 10 through 23.

Aspect 39: An apparatus for wireless communications at a first network entity, comprising one or more memories storing processor-executable code, and one or more processors coupled with the one or more memories and individually or collectively operable to execute the code to cause the first network entity to perform a method of any of aspects 24 through 32.

Aspect 40: A first network entity for wireless communications, comprising at least one means for performing a method of any of aspects 24 through 32.

Aspect 41: A non-transitory computer-readable medium storing code for wireless communications at a first network entity, the code comprising instructions executable by one or more processors to cause the first network entity to perform a method of any of aspects 24 through 32.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive, from a first network entity, a control message that includes an indication of one or more monitoring parameters associated with life cycle management of one or more artificial intelligence-based functionalities or models of the UE; and
perform, based at least in part on satisfaction of at least one monitoring parameter of the one or more monitoring parameters for a communication link associated with a second network entity, a life cycle management action associated with at least one artificial intelligence-based functionality or model of the one or more artificial intelligence-based functionalities or models.

2. The apparatus of claim 1, wherein the one or more processors are configured to cause the UE to:
transmit, to one of the first network entity or the second network entity, a life cycle management request message, wherein the life cycle management action is performed based at least in part on the life cycle management request message.

3. The apparatus of claim 2, wherein the one or more processors are configured to cause the UE to:
receive, from the first network entity or the second network entity and based at least in part on the life cycle management request message, a life cycle management control message that indicates a configuration for the at least one artificial intelligence-based functionality or model, wherein the life cycle management action is based at least in part on the configuration, wherein the life cycle management request message comprises a request for the configuration.

4. The apparatus of claim 1, wherein the one or more processors are configured to cause the UE to:
transmit, to one of the first network entity or the second network entity, a second control message that indicates performance of the life cycle management action.

5. The apparatus of claim 1, wherein, to perform the life cycle management action, the one or more processors are configured to cause the UE to:
activate the at least one artificial intelligence-based functionality or model, deactivate the at least one artificial intelligence-based functionality or model, switch the at least one artificial intelligence-based functionality or model from a first configuration to another artificial intelligence-based functionality, or switch the at least one artificial intelligence-based functionality or model to a non-artificial intelligence-based UE function.

6. The apparatus of claim 1, wherein:
the one or more artificial intelligence-based functionalities or models include layer 1 beam predictions, layer 3 beam measurements, radio link failure predictions, handover predictions, beam failure predictions, measurement event prediction, or a combination thereof; and
the one or more monitoring parameters comprise an accuracy of the layer 1 beam predictions, an accuracy of the layer 3 beam measurements, an accuracy of the radio link failure predictions, an accuracy of the handover predictions, an accuracy of the beam failure predictions, satisfaction of a counter, or a combination thereof.

7. An apparatus for wireless communication at a first network entity, comprising:
one or more memories; and
one or more processors coupled with the one or more memories and configured to cause the first network entity to:
obtain a capability message that indicates one or more artificial intelligence-based functionalities or models of a user equipment (UE);
obtain, from a second network entity, a control message that indicates one or more performance parameters associated with the UE, the one or more performance parameters associated with at least one artificial intelligence-based functionality or model of the one or more artificial intelligence-based functionalities or models; and
output, based at least in part on the capability message and the control message, a life cycle management control message that indicates a configuration for the at least one artificial intelligence-based functionality or model.

8. The apparatus of claim 7, wherein, to obtain the control message from the second network entity, the one or more processors are configured to cause the first network entity to:
obtain, from a registration entity, a message that includes an indication of a logical or physical model associated with a UE type of the UE, the logical or physical model associated with the one or more performance parameters, wherein the registration entity comprises the second network entity.

9. The apparatus of claim 8, wherein the one or more processors are configured to cause the first network entity to:
obtain, from the registration entity, advertisement information that indicates a set of UE types or a set of respective logical models, wherein the set of UE types includes the UE type, or the set of respective logical models includes the logical or physical model.

10. The apparatus of claim 8, wherein the one or more processors are configured to cause the first network entity to:
obtain, from a third network entity, one or more additional performance indicators associated with the one or more performance parameters, wherein transmission of the life cycle management control message is based at least in part on an application of the one or more additional performance indicators to the logical or physical model.

11. The apparatus of claim 7, wherein, to obtain the control message from the second network entity, the one or more processors are configured to cause the first network entity to:
obtain, from an access and mobility entity, the control message that indicates the configuration for the at least one artificial intelligence-based functionality or model, wherein the one or more performance parameters are associated with the configuration.

12. The apparatus of claim 7, wherein, to obtain the control message from the second network entity, the one or more processors are configured to cause the first network entity to:
obtain, from an operations and management entity, the control message that indicates the configuration for the at least one artificial intelligence-based functionality or model, wherein the configuration includes the one or more performance parameters.

13. The apparatus of claim 7, wherein the one or more processors are configured to cause the first network entity to:
obtain assistance information that indicates an identifier for the UE; and
output, to the second network entity, a request message for one or more additional performance indicators for the UE, wherein the request message includes the identifier for the UE, and wherein obtention of the control message comprises obtention of the one or more additional performance indicators for the UE associated with the one or more performance parameters based at least in part on inclusion of the identifier in the request message.

14. The apparatus of claim 13, wherein the one or more processors are configured to cause the first network entity to:
output, to the second network entity, a report that indicates one or more second performance indicators associated with the configuration for the at least one artificial intelligence-based functionality or model based at least in part on communication between the UE and the first network entity.

15. The apparatus of claim 7, wherein:
the configuration comprises activation of the at least one artificial intelligence-based functionality or model, deactivation of the at least one artificial intelligence-based functionality or model, switch of the at least one artificial intelligence-based functionality or model from a second configuration to another artificial intelligence-based functionality or model, or switch of the at least one artificial intelligence-based functionality or model to a non-artificial intelligence-based UE function;
the one or more artificial intelligence-based functionalities or models include layer 1 beam predictions, layer 3 beam measurements, radio link failure predictions, handover predictions, beam failure predictions, or a combination thereof; or
the one or more performance parameters comprises an accuracy of the layer 1 beam predictions, an accuracy of the layer 3 beam measurements, an accuracy of the radio link failure predictions, an accuracy of the handover predictions, an accuracy of the beam failure predictions, satisfaction of a counter, or a combination thereof.

16. An apparatus for wireless communication at a first network entity, comprising:
one or more memories; and
one or more processors coupled with the one or more memories and configured to cause the first network entity to:
obtain, from a second network entity, a first control message that indicates one or more performance parameters associated with a user equipment (UE), the one or more performance parameters associated with at least one artificial intelligence-based functionality or model of one or more artificial intelligence-based functionalities or models of the UE; and
output, to a third network entity in communication with the UE, a second control message based at least in part on the one or more performance parameters.

17. The apparatus of claim 16, wherein, to output the second control message, the one or more processors are configured to cause the first network entity to:
output a life cycle management control message that indicates a configuration for the at least one artificial intelligence-based functionality or model.

18. The apparatus of claim 17, wherein, to obtain the first control message from the second network entity, the one or more processors are configured to cause the first network entity to:
obtain, from an operations and management entity, the first control message that indicates the configuration for the at least one artificial intelligence-based functionality or model, wherein the configuration includes the one or more performance parameters.

19. The apparatus of claim 16, wherein the one or more processors are configured to cause the first network entity to:
communicate, with the second network entity and prior to obtention of the first control message, a third control message that indicates a subscription for a model identifier associated with the UE, the model identifier associated with the one or more performance parameters;
receive, from the third network entity, a first report message that indicates one or more additional performance indicators for the UE associated with the at least one artificial intelligence-based functionality or model; and
output, to the second network entity, a second report message that indicates the one or more additional performance indicators, wherein obtention of the first control message is based at least in part on the second report message.

20. The apparatus of claim 19, wherein the one or more processors are configured to cause the first network entity to:
obtain, from the third network entity, a first request message for the one or more performance parameters; and
output, to the second network entity and based at least in part on the first request message, a second request message for the one or more performance parameters, wherein obtention of the first control message is based at least in part on the second request message.
